(19) United States
(12) Patent Application Publication
(10) Pub. No.: US 2021/0206382 A1
(43) Pub. Date: Jul. 8, 2021

(54) INFORMATION PROCESSING APPARATUS, INFORMATION PROCESSING SYSTEM, INFORMATION PROCESSING METHOD, AND PROGRAM

(71) Applicant: SONY CORPORATION, Tokyo (JP)

(72) Inventor: Kento NAKADA, Tokyo (JP)

(73) Assignee: SONY CORPORATION, Tokyo (JP)

(21) Appl. No.: 17/258,329

(22) PCT Filed: Jun. 21, 2019
(86) PCT No.: PCT/JP2019/024659

§ 371 Date: Jan. 6, 2021

(30) Foreign Application Priority Data
Aug. 17, 2018 (JP) 2018-153365

(51) Int. Cl. B60W 40/09; G06N 20/00; G01C 21/00; G06K 9/62; B60W 50/14; B60W 40/08

(52) U.S. Cl. CPC B60W 40/09; G06N 20/00; B60W 2040/0863; G06K 9/6262; B60W 50/14; G01C 21/387

(57) ABSTRACT

A configuration is realized that inputs terminal-acquired information of a mobile terminal in a vehicle to a learning model, estimates a driver's driving behavior, and performs processes such as calculating a score on the basis of an estimation result and giving a notice. Terminal-acquired information such as acceleration information acquired by the mobile terminal in the vehicle is input, and a process of estimating a driving behavior of the driver of the vehicle is performed. A driving behavior estimate of the driver and estimation reliability of the driving behavior estimate are calculated on the basis of the terminal-acquired information by applying a learning model. Further, processes of calculating a risk score as an index representing a degree of driving risk of the driver, a reliability score as an index value of overall estimation reliability of the driving behavior estimate, an overall score representing a driving diagnosis result of the driver, and the like are performed, and a notification process of giving a notice to a user of the mobile terminal on the basis of the scores and the like are performed.

### TECHNICAL FIELD

The present disclosure relates to an information processing apparatus, an information processing system, an information processing method, and a program. In more detail, the present disclosure relates to an information processing apparatus, an information processing system, an information processing method, and a program that analyze a driving behavior by using information acquired by a mobile terminal carried by a vehicle's driver or a passenger.

### BACKGROUND ART

Machine learning algorithms have found application in a wide variety of fields in recent years. One example thereof is a system using machine learning for assessing a driving behavior of an automobile driver.

PTL 1 (Japanese Patent No. 6264492) discloses a system that assesses a degree of driver's concentration on driving on the basis of a captured image of a driver's face.

However, it has been common for many of conventional driving behavior assessment systems to assess the driver's behavior by using image capture information of a camera, vehicle's steering wheel maneuver information, accelerator or brake maneuver information, and the like.

Such an assessment processing system is an apparatus integral with a vehicle, and in the case where the vehicle is not equipped with such a system, one cannot use the system.

### CITATION LIST

### Patent Literature

### [PTL 1]

Japanese Patent No. 6264492

### SUMMARY

### Technical Problem

The present disclosure has been devised, for example, in light of the foregoing, and it is an object of the present disclosure to provide an information processing apparatus, an information processing system, an information processing method, and a program capable of analyzing and assessing a driving behavior on the basis of information acquired by a mobile terminal such as a smartphone held by a vehicle's driver or passenger.

### Solution to Problem

A first aspect of the present disclosure is an information processing apparatus including a data processing section configured to receive input of terminal-acquired information that is information acquired by a mobile terminal in a vehicle and perform a process of estimating a driving behavior of a driver of the vehicle. The data processing section calculates a driving behavior estimate of the driver on the basis of the terminal-acquired information by applying a learning model generated in advance.

Further, a second aspect of the present disclosure is an information processing system including a management server and a mobile terminal. The mobile terminal includes a mobile terminal provided in a vehicle, and terminal-acquired information acquired by the mobile terminal is transmitted to the management server. The management server inputs the terminal-acquired information received from the mobile terminal to a learning model to output a driving behavior estimate of a driver of the vehicle.

Further, a third aspect of the present disclosure is an information processing method performed in an information processing apparatus. The information processing apparatus includes a data processing section configured to receive input of terminal-acquired information that is information acquired by a mobile terminal in a vehicle, and perform a process of estimating a driving behavior of a driver of the vehicle. The data processing section calculates a driving behavior estimate of the driver on the basis of the terminal-acquired information by applying a learning model generated in advance.

Further, a fourth aspect of the present disclosure is an information processing method performed in an information processing system including a management server and a mobile terminal. The mobile terminal includes a mobile terminal provided in a vehicle, and terminal-acquired information acquired by the mobile terminal is transmitted to the management server. The management server inputs the terminal-acquired information received from the mobile terminal to a learning model to output a driving behavior estimate of a driver of the vehicle.

Further, a fifth aspect of the present disclosure is a program for causing information processing to be performed in an information processing apparatus. The information processing apparatus includes a data processing section configured to receive input of terminal-acquired information that is information acquired by a mobile terminal in a vehicle and perform a process of estimating a driving behavior of a driver of the vehicle. The program causes the data processing section to calculate a driving behavior estimate of the driver on the basis of the terminal-acquired information by applying a learning model generated in advance.

It should be noted that the program of the present disclosure is, for example, a program that can be provided by a storage medium or a communication medium that provides the program in a computer-readable manner to an information processing apparatus or a computer system capable of executing various codes. The provision of such a program in a computer-readable form enables the information processing apparatus or the computer system to realize processing according to the program.

Still other objects, features, and advantages of the present disclosure will become apparent from a detailed description given later on the basis of an embodiment and attached drawings of the present disclosure. It should be noted that the term “system” in the present specification has a configuration that includes a logical set of a plurality of apparatuses, and that the apparatuses, each serving as a component, need not necessarily be accommodated in the same housing.

### Advantageous Effect of the Invention

According to a configuration of an embodiment of the present disclosure, a configuration is realized that inputs terminal-acquired information of a mobile terminal in a vehicle to a learning model, estimates a driver's driving behavior, and performs processes such as calculating a score on the basis of the estimation result and giving a notice.

Specifically, for example, terminal-acquired information such as acceleration information acquired by a mobile terminal in a vehicle is input, and a process of estimating a driving behavior of a driver of the vehicle is performed. A driving behavior estimate of the driver and estimation reliability of the driving behavior estimate are calculated on the basis of the terminal-acquired information by applying a learning model. Further, processes of calculating a risk score that is an index representing a degree of driving risk of the driver, a reliability score that is an index value of overall estimation reliability of the driving behavior estimate, an overall score representing a driving diagnosis result of the driver, and the like are performed, and a notification process of giving a notice to a mobile terminal user on the basis of the scores and the like are performed.

The present configuration realizes a configuration that inputs terminal-acquired information of a mobile terminal in a vehicle to a learning model, estimates a driver's driving behavior, and performs processes such as calculating a score on the basis of the estimation result and giving a notice.

It should be noted that advantageous effects described in the present specification are merely illustrative and not restrictive, and that there may be additional advantageous effects.

### BRIEF DESCRIPTION OF DRAWINGS

FIG. 1 is a diagram outlining processes of the present disclosure.

FIG. 2 is a diagram describing an example of information acquired by a mobile terminal.

FIG. 3 is a diagram describing a learning model generation process by a management server.

FIG. 4 is a diagram describing an example of observation information.

FIG. 5 is a diagram describing the learning model generation process performed by a learning process section of the management server and is a diagram describing an example of driving behavior data.

FIG. 6 is a diagram describing a data example of learning data.

FIG. 7 is a diagram describing an example of a driving behavior estimation process performed by the management server by use of a learning model.

FIG. 8 is a diagram illustrating a flowchart describing a processing sequence of the driving behavior estimation process performed by the management server by use of the learning model.

FIG. 9 is a diagram describing a specific example of an estimation reliability calculation process.

FIG. 10 is a diagram describing a driving behavior estimation application stored in the mobile terminal.

FIG. 11 is a diagram describing main functions of the driving behavior estimation application.

FIG. 12 is a diagram illustrating a flowchart describing a processing sequence of the driving behavior estimation process performed by the mobile terminal and the management server by use of the learning model.

FIG. 13 is a diagram illustrating a flowchart describing a processing sequence of a score calculation process using a driving behavior estimation result.

FIG. 14 is a diagram describing stored data in a driving behavior analysis result DB (database) generated by the management server.

FIG. 15 is a diagram describing stored data in the driving behavior analysis result DB (database) generated by the management server.

FIG. 16 is a diagram describing category-by-category score analysis data.

FIG. 17 is a diagram illustrating a flowchart describing a processing sequence of a road zone setting process on the basis of the category-by-category score analysis data.

FIG. 18 is a diagram illustrating a flowchart describing a processing sequence prior to start of traveling by use of the driving behavior estimation application executed by the mobile terminal.

FIG. 19 is a diagram illustrating an example of a display screen on the mobile terminal.

FIG. 20 is a diagram illustrating an example of a display screen on the mobile terminal.

FIG. 21 is a diagram illustrating a flowchart describing a processing sequence during traveling by use of the driving behavior estimation application executed by the mobile terminal.

FIG. 22 is a diagram illustrating an example of a display screen of the mobile terminal.

FIG. 23 is a diagram illustrating an example of a display screen of the mobile terminal.

FIG. 24 is a diagram illustrating an example of a display screen of the mobile terminal.

FIG. 25 is a diagram illustrating a flowchart describing a processing sequence after traveling by use of the driving behavior estimation application executed by the mobile terminal.

FIG. 26 is a diagram illustrating examples of a display screen of the mobile terminal.

FIG. 27 is a diagram illustrating examples of a display screen of the mobile terminal.

FIG. 28 is a diagram illustrating a flowchart describing a processing sequence after traveling by use of the driving behavior estimation application executed by the mobile terminal.

FIG. 29 is a diagram illustrating an example of a display screen of the mobile terminal.

FIG. 30 is a diagram illustrating a hardware configuration example of an information processing apparatus applicable as a mobile terminal or a management server.

### DESCRIPTION OF EMBODIMENT

A detailed description will be given below of an information processing apparatus, an information processing system, an information processing method, and a program of the present disclosure with reference to drawings. It should be noted that the description will be given regarding the following items.

1. Outline of the processes of the present disclosure

2. Learning model generation process for estimating a driving behavior from terminal-acquired information

3. Driving behavior estimation process using a learning model

4. Processes using a driving behavior estimation application of the mobile terminal

5. Processes using the driving behavior estimation application after creating a driving behavior analysis DB

5-(1) Process before start of traveling by use of the driving behavior estimation application

5-(2) Process during traveling by use of the driving behavior estimation application

5-(3) Process after traveling by use of the driving behavior estimation application

6. Configuration example of the information processing apparatus

7. Conclusion of the configuration of the present disclosure

### [1. Outline of the Processes of the Present Disclosure]

The present disclosure enables, for example, analysis and assessment of a driving behavior on the basis of information acquired by a mobile terminal such as a smartphone carried by a vehicle's driver or a passenger.

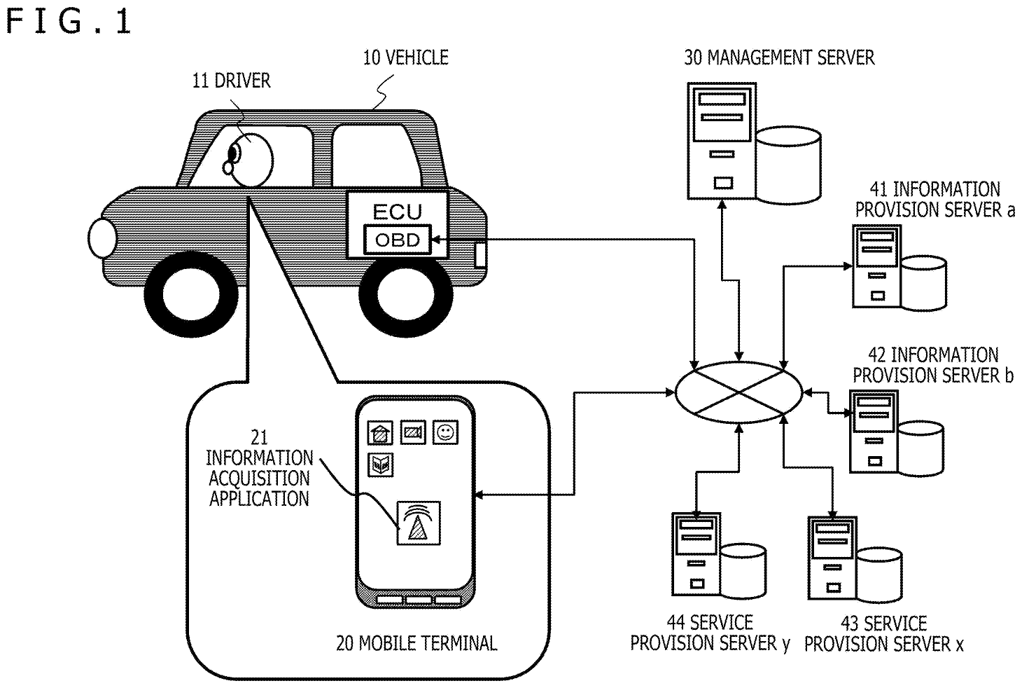

The processes of the present disclosure will be outlined with reference to FIG. 1.

FIG. 1 illustrates a vehicle 10. The vehicle 10 is driven by a driver 11.

The driver 11 or a passenger, not illustrated, carries a mobile terminal such as a smartphone which is a mobile terminal 20 depicted in FIG. 1.

The vehicle 10 has an ECU (Electrical Control Unit) that is a control unit for performing processes such as controlling the vehicle 10 and acquiring operation information. The ECU has an OBD (On-Board Diagnostics) as a component thereof. The OBD is a function of the ECU and is a program that mainly provides a diagnostic function of the vehicle 10.

The OBD provided in the ECU of the vehicle 10 transmits information regarding the vehicle 10 such as vehicle speed and acceleration information to a management server 30 via a network one after another.

The mobile terminal 20 carried by the driver 11 or the passenger can communicate with not only the management server 30 but also a plurality of information provision servers 41, 42, and so forth and service provision servers 43, 44, and so forth via a network.

The information provision servers 41, 42, and so forth include a traffic information provision server, a weather information provision server, and the like that provide a variety of information. The service provision servers 43, 44, and so forth include a server of an insurance company, a server for merchandise sales, and the like that provide a variety of services.

The mobile terminal 20 has an information acquisition application 21 installed therein in advance.

The information acquisition application 21 acquires a variety of information that can be used to analyze or assess a driving behavior of the driver 11.

Information acquired by the mobile terminal 20 includes, for example, the following information.

(1) information acquired from an acceleration sensor or a GPS incorporated in the mobile terminal itself

(2) information acquired via the information provision servers 41 and 42 (e.g., traffic information)

The mobile terminal 20 can acquire these various pieces of information.

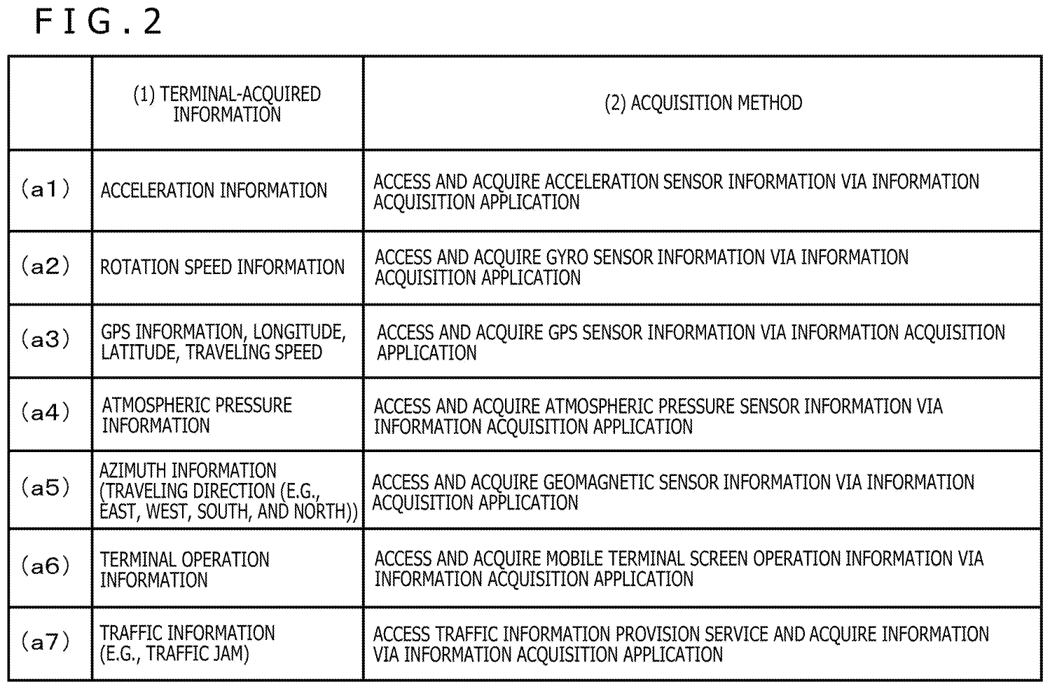

FIG. 2 illustrates an example of information acquired by the mobile terminal 20. As illustrated in FIG. 2, the mobile terminal 20 acquires, for example, the following information.

(a1) acceleration information

(a2) rotation speed information

(a3) GPS information (e.g., longitude, latitude, and speed information)

(a4) atmospheric pressure information

(a5) azimuth information (traveling direction (e.g., East, West, South, and North))

(a6) terminal operation information

(a7) traffic information

(a1) Acceleration information is acquired, for example, from an acceleration sensor of the mobile terminal 20 itself.

(a2) Rotation speed information is acquired, for example, from a gyro sensor of the mobile terminal 20 itself.

(a3) GPS information (e.g., longitude, latitude, and speed information) is acquired, for example, from a GPS sensor of the mobile terminal 20 itself.

(a4) Atmospheric pressure information is acquired, for example, from an atmospheric pressure sensor of the mobile terminal 20 itself.

(a5) Azimuth information (traveling direction (e.g., East, West, South, and North)) is acquired, for example, from a geomagnetic sensor of the mobile terminal 20 itself.

(a6) Terminal operation information is acquired, for example, from an operation information detection sensor of the mobile terminal 20 itself.

(a7) Traffic information is acquired, for example, from an external traffic information provision server (information provision server).

As described above, the mobile terminal 20 can acquire a variety of information from its own sensors and external servers.

The acquired pieces of information are transmitted from the mobile terminal 20 to the management server 30 one after another.

[2. Learning Model Generation Process for Estimating a Driving Behavior from Terminal-Acquired Information]

The present disclosure enables analysis and assessment of a driving behavior of the driver 11 driving the vehicle 10 on the basis of information acquired by the mobile terminal 20.

In order to enable this process, it is necessary to generate a learning model first.

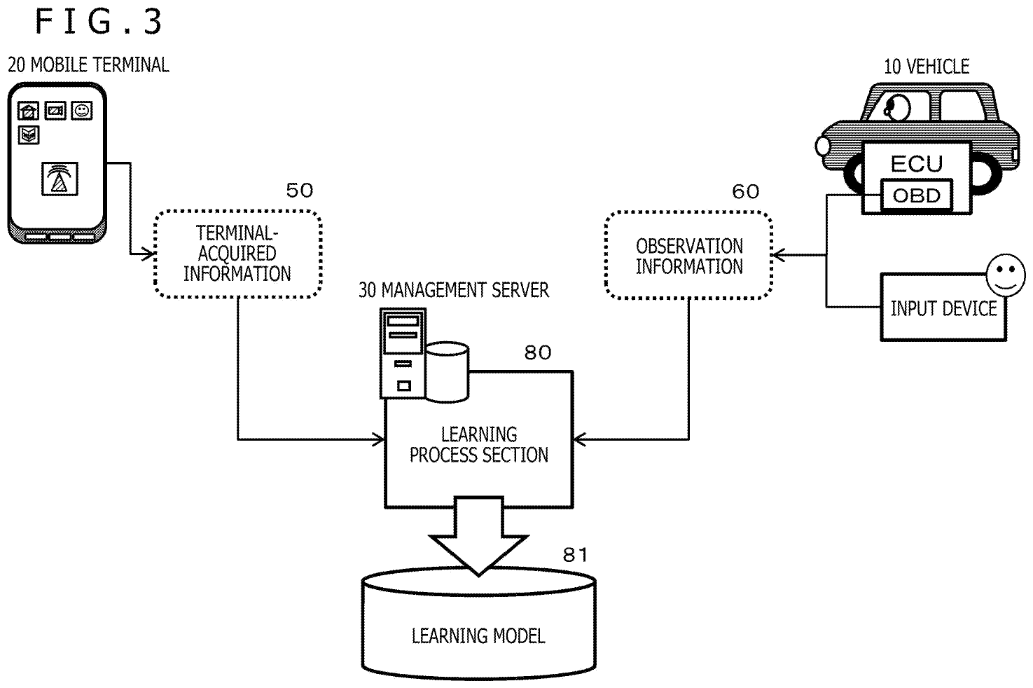

A learning model generation process will be described with reference to FIG. 3 and subsequent figures.

The learning model generation process is performed by the management server 30.

FIG. 3 is a diagram describing a generation process of a learning model 81 by the management server 30.

That is, FIG. 3 is a diagram describing a process of generating the learning model 81 applied to analyze and assess the driving behavior of the driver 11 driving the vehicle 10 on the basis of information acquired by the mobile terminal 20.

As illustrated in FIG. 3, a learning process section 80 of the management server 30 acquires terminal-acquired information 50 from the mobile terminal 20.

Further, the learning process section 80 of the management server 30 acquires observation information 60 that includes the OBD provided in the ECU of the vehicle 10 and other input information.

The following two kinds of information are learning data applied for the learning process performed by the learning process section 80 of the management server 30.

(a) terminal-acquired information 50 from the mobile terminal 20

(b) observation information 60 including the OBD provided in the ECU of the vehicle 10 and other input information

The learning model 81 is generated by the learning process using these pieces of learning data.

The terminal-acquired information 50 acquired from the mobile terminal 20 is, for example, a variety of pieces of information, namely, (a1) to (a7) described earlier with reference to FIG. 2.

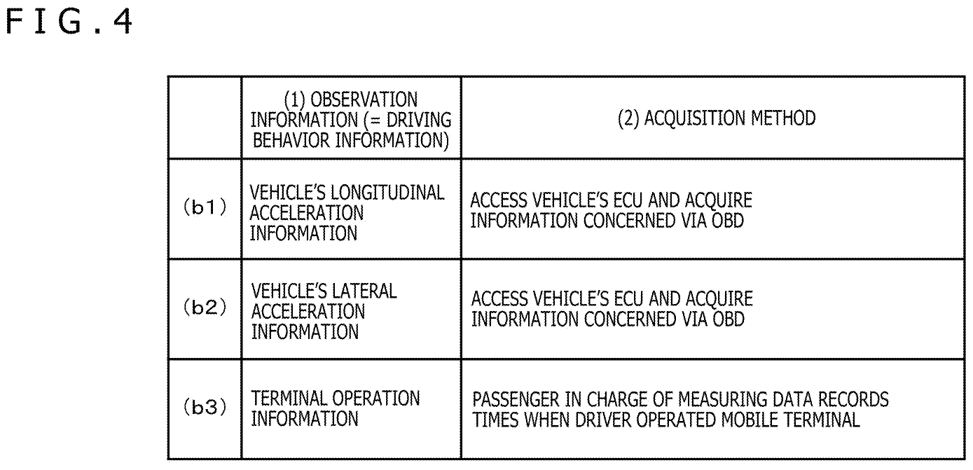

Meanwhile, a description will be given of the observation information 60 that includes the OBD provided in the ECU of the vehicle 10 and other input information with reference to FIG. 4.

FIG. 4 illustrates an example of the observation information 60. As illustrated in FIG. 4, the observation information 60 includes, for example, the following information.

(b1) vehicle's longitudinal acceleration information

(b2) vehicle's lateral acceleration information

(b3) terminal operation information

It should be noted that these pieces of observation information are actual observation information of the driving behavior of the driver 11 and corresponds to actual driving behavior information.

(b1) Vehicle's longitudinal acceleration information is actual longitudinal acceleration information of the vehicle 10 acquired from the OBD provided in the ECU of the vehicle 10.

(b2) Vehicle's lateral acceleration information is actual lateral acceleration information of the vehicle 10 acquired from the OBD provided in the ECU of the vehicle 10.

(b3) Terminal operation information is, for example, information input from a terminal carried by a passenger other than the driver of the vehicle 10 and is actual observation information representing whether or not the driver is operating the mobile terminal 20.

It should be noted that these pieces of information are acquired and transmitted to the management server 30 in the case where the process of generating the learning model 81 is performed.

After the generation of the learning model 81, the process of acquiring these pieces of observation information is no longer necessary.

After the generation of the learning model 81, it is possible to perform a process of estimating the driving behavior of the driver 11 from information acquired by the mobile terminal 20 by applying the generated learning model 81.

It should be noted that in the case where the learning process section 80 of the management server 30 updates the learning model 81, the learning process section 80 can update the learning model 81 by acquiring the new terminal-acquired information 50 and observation information 60 and performing the learning process by use of these pieces of information as new learning data.

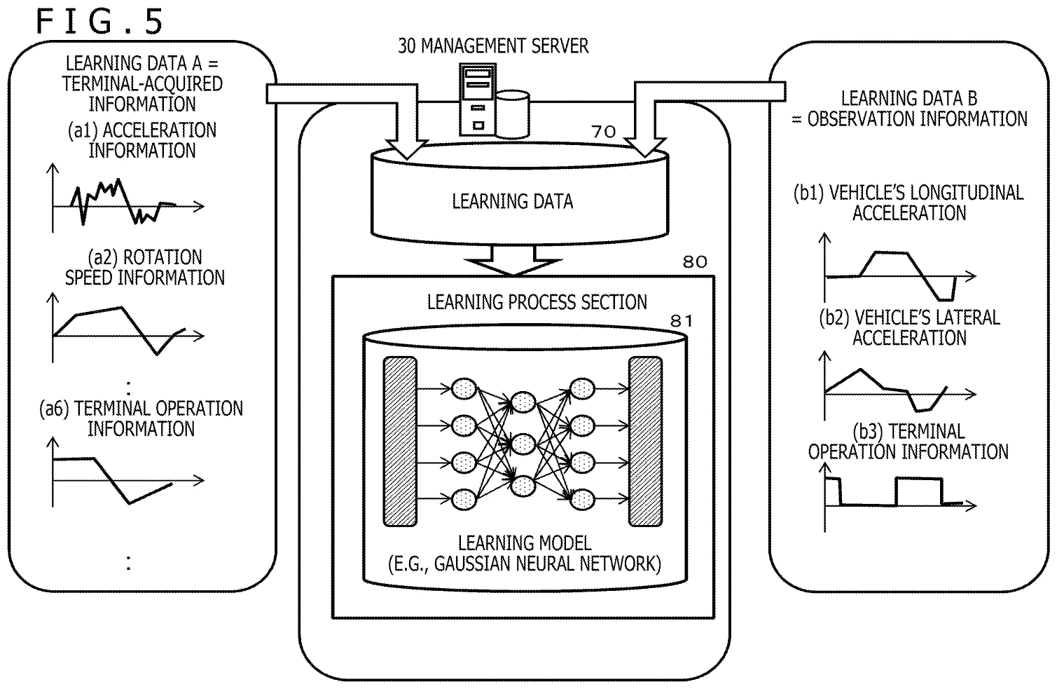

A description will be given of a specific example of the process of generating the learning model 81, i.e., a learning process, performed by the learning process section 80 of the management server 30, with reference to FIG. 5.

FIG. 5 illustrates the learning process section 80 of the management server 30 and the learning model 81 generated as a result of the learning process performed by the learning process section 80.

First, the learning process section 80 of the management server 30 collects learning data 70 to be applied for the learning process. The collected learning data 70 include the following data.

(A) terminal-acquired information

(B) observation information (=driving behavior information)

The (A) terminal-acquired information is the terminal-acquired information 50 acquired by the mobile terminal 20 illustrated in FIG. 3 and is, for example, a variety of pieces of information, namely, (a1) to (a7) described earlier with reference to FIG. 2.

Meanwhile, the (B) observation information is the observation information 60 that includes the OBD provided in the ECU of the vehicle 10 illustrated in FIG. 3 and other input information and is, for example, a variety of pieces of observation information (=driving behavior information), namely, (b1) to (b3) described earlier with reference to FIG. 4.

It should be noted that each of these pieces of information is chronological data and acquired as data corresponding to a time axis.

The learning process section 80 of the management server 30 performs the learning process on the basis of these pieces of learning data 70. That is, the learning process section 80 is caused to learn a machine learning algorithm by use of the collected learning data 70. An optimal choice as a machine learning algorithm is an algorithm with which reliability (estimation reliability) of an estimation result using a learning model can be calculated such as a Gaussian process or a Bayesian neural network.

Estimation reliability is an index representing the extent to which an estimation result is correct. For example, the higher the match between a pattern included in learning data in machine learning and a behavior pattern at the time of estimation, the higher the reliability.

It should be noted that a value in the range of 1 to 0, for example, is used as estimation reliability. The highest estimation reliability is 1, and the lowest estimation reliability is 0.

It should be noted that, in the present embodiment, the estimation reliability is estimation reliability of a driver's behavior estimate made by applying a learning model on the basis of terminal-acquired information.

In order to increase the estimation reliability, it is effective to perform the learning process by using a larger amount of learning data.

FIG. 5 illustrates an example of generating a (machine) learning model using a Gaussian neural network as an example of a learning process performed by the learning process section 80. A variety of ways are available for designing a learning model. For example, there is provided a technique that inputs all kinds of terminal-acquired information (e.g., (a1) to (a7) illustrated in FIG. 2) to a single model to simultaneously estimate all driving behavior information (e.g., (b1) to (b3) illustrated in FIG. 4) as estimation data.

Further, for example, in the case where it has been discovered, as a result of analysis, that specific terminal-acquired information and specific driving behavior information are highly correlated, and in the case where a specific driving behavior is estimated, one technique preferentially selects terminal-acquired information highly correlated with that behavior for estimation.

In the present embodiment, a description will be given of an example of generating, as an example of a learning model, a learning model capable of outputting one or more pieces of driving behavior information as output information by simultaneously inputting a plurality of pieces of information selected from among terminal-acquired information to the learning process section 80.

A learning process sequence will be described briefly.

(S1) Designing a Machine Learning Model

First, a (machine) learning model to be used for the learning process is designed as a process in step S1.

Various parameters of the machine learning model are designed on the basis of a predetermined theoretical model (e.g., Gaussian process and Bayesian neural network) to suit corresponding input and output signals. Examples of parameters include a mean function or a covariance function in the case of the Gaussian process and the number of network layers or an activation function in the case of the Bayesian neural network.

(S2) Learning Process to which the Machine Learning Model is Applied

Next, in step S2, a learning process to which the machine learning model is applied is performed. In this learning process, the above learning data 70 is used. The following learning data 70 are collected.

(A) terminal-acquired information

(B) observation information (driving behavior information)

It should be noted that, as described earlier, each of these pieces of information is chronological data and acquired as data corresponding to the time axis.

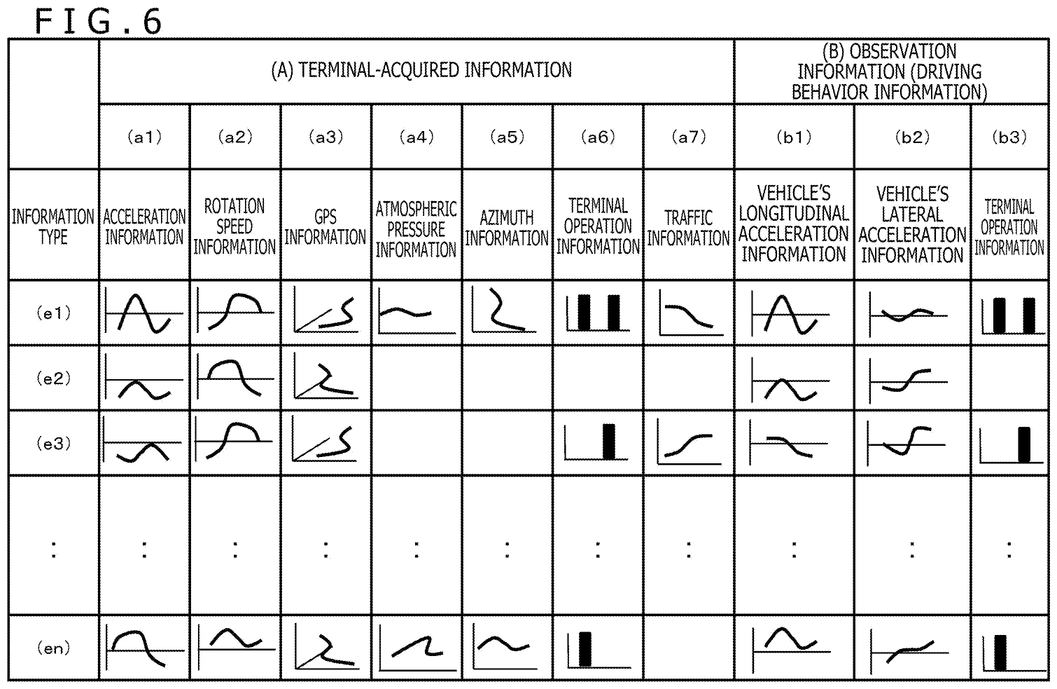

FIG. 6 illustrates a data example of the learning data 70.

As illustrated in FIG. 6, the learning data includes data corresponding to the following.

(A) terminal-acquired information

(B) observation information (driving behavior information)

FIG. 6 illustrates a plurality of entries (e1) to (en). Each of these entries includes data corresponding to one or more pieces of terminal-acquired information and observation information (driving behavior information).

At the time of the learning process, the machine learning model parameters are optimized by using learning data with a synchronous time series, i.e., the respective entries (e1) to (en) illustrated in FIG. 6. The optimization method depends on the theoretical model used.

As a result of these learning processes, the learning model 81 is generated that can output an output signal (=driving behavior estimate) on the basis of a variety of input signals (=terminal-acquired information).

By using the learning model 81, it is possible to output an optimal output signal, i.e., a driving behavior estimate, even for an input signal (=terminal-acquired information) that does not match any of the input signals (=terminal-acquired information) of the entries included in the learning data (refer to FIG. 6) applied for the learning process.

It should be noted that the learning model 81 is a model to which an algorithm capable of calculating reliability (estimation reliability) of an estimation result produced by use of a learning model, such as the Gaussian process or the Bayesian neural network, is applied and outputs, together with a driving behavior estimate, estimation reliability representing reliability of the driving behavior estimate.

### [3. Driving Behavior Estimation Process Using a Learning Model]

A description will next be given of a driving behavior estimation process using the learning model generated by the above learning process.

In this process, the management server 30 acquires information acquired by the mobile terminal 20 carried by the driver 11 or a passenger of the vehicle 10 and estimates the driving behavior of the driver 11 by using the learning model 81 generated by the learning process described earlier.

Further, in the present embodiment, the estimation reliability that is the reliability of the driving behavior estimate is also generated and output as described earlier. A value in the range of 1 to 0 is, for example, used as the estimation reliability. The highest estimation reliability is 1, and the lowest estimation reliability is 0.

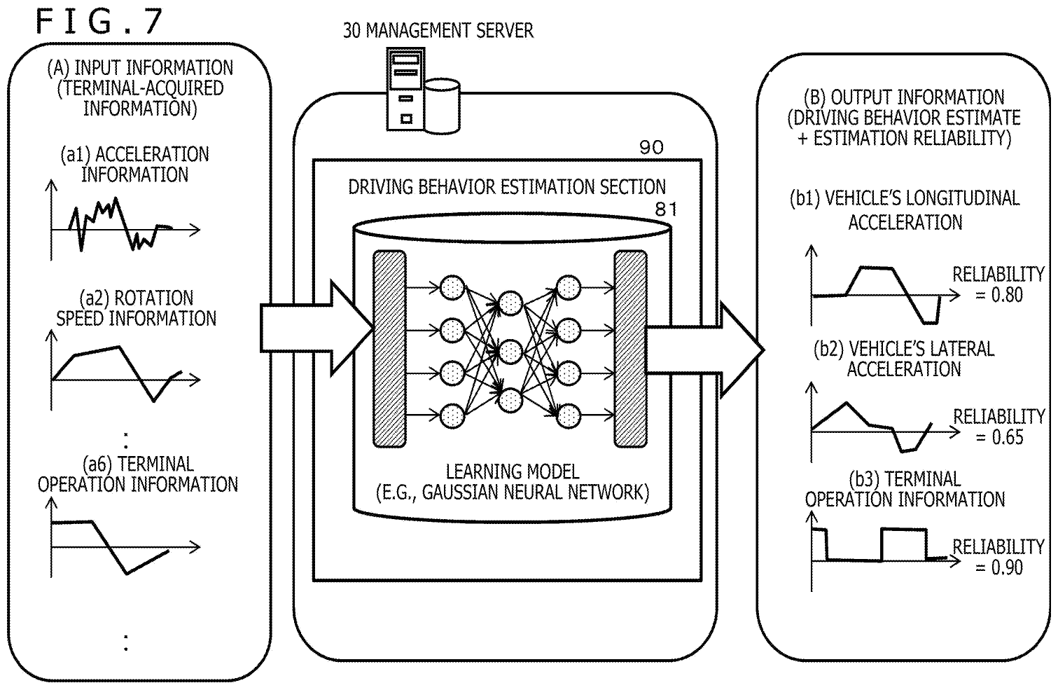

FIG. 7 illustrates a processing example of the management server 30 that performs the driving behavior estimation process using a learning model.

A driving behavior estimation section 90 that is a data processing section of the management server 30 receives terminal-acquired information from the mobile terminal of the user in the vehicle via a network.

This terminal-acquired information includes the following, as described earlier with reference to FIG. 2.

(a1) acceleration information

(a2) rotation speed information

(a3) GPS information (e.g., longitude, latitude, and speed information)

(a4) atmospheric pressure information

(a5) azimuth information (traveling direction (e.g., East, West, South, and North))

(a6) terminal operation information

(a7) traffic information

It should be noted that all these pieces of information need not necessarily be received as input and that only some thereof may be received as input.

When the terminal-acquired information is input, the driving behavior estimation section 90 as the data processing section of the management server 30 estimates driving behavior information from the input terminal-acquired information by using the learning model 81 generated in advance.

If there exists a data set (entry) that completely matches the input terminal-acquired information in the learning model 81, it is possible to output the driving behavior information associated with the entry of the learning model as a driving behavior estimate. In this case, the estimation reliability of the output (driving behavior estimate) is a value close to 1 (highest reliability).

In reality, however, it is unlikely that there exists a data set (entry) that completely matches the input terminal-acquired information in the learning model 81.

In an actual estimation process, learning models similar to the input terminal-acquired information are used in combination to calculate and output a final driving behavior estimate. In this case, for example, estimation reliability according to the similarity between the terminal-acquired information that has been received as input and the data set of the learning model used is calculated.

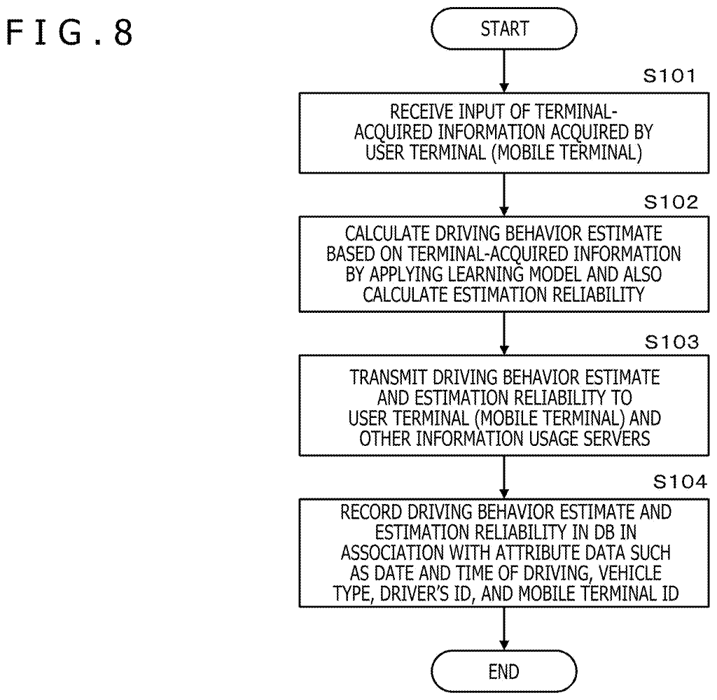

A description will be given of a processing sequence of the driving behavior estimation process performed by the management server 30 by using the learning model with reference to a flowchart illustrated in FIG. 8.

It should be noted that the process according to this flow is performed under control of the control section (data processing section) incorporating a CPU or the like having a program execution function in accordance with a program stored in a storage section of the management server 30. Processes in the respective steps in the flow illustrated in FIG. 8 will be described in order.

(Step S101)

First, in step S101, the management server 30 receives input of terminal-acquired information acquired by the user terminal (mobile terminal). The terminal-acquired information includes the following information described earlier with reference to FIG. 2.

(a1) acceleration information

(a2) rotation speed information

(a3) GPS information (e.g., longitude, latitude, and speed information)

(a4) atmospheric pressure information

(a5) azimuth information (traveling direction (e.g., East, West, South, and North))

(a6) terminal operation information

(a7) traffic information

It should be noted that all these pieces of information need not necessarily be received as input and that only some thereof may be received as input.

It should be noted that attribute data such as date and time of driving, a vehicle type, a driver's ID, and a mobile terminal ID is transmitted together with the above terminal-acquired information from the user terminal (mobile terminal), and that the management server acquires these pieces of data and records the data to the DB together with an estimation result to be acquired by the estimation process to be performed next.

(Step S102)

Next, in step S102, the driving behavior estimation section 90 as the data processing section of the management server 30 calculates a driving behavior estimate on the basis of the terminal-acquired information by applying a learning model and also calculates the reliability (estimation reliability) of the calculated driving behavior estimate.

As described earlier, the driving behavior estimation section 90 of the management server 30 inputs input information, i.e., terminal-acquired information, to a learning model that performs an algorithm such as the Gaussian process or the Bayesian neural network to output a driving behavior estimate as an output value. Further, the driving behavior estimation section 90 calculates estimation reliability of the driving behavior estimate that is the output value.

The reliability (estimation reliability) is calculated corresponding to each estimated driving behavior item. As described earlier, the reliability has a value in the range of 0 (low reliability) to 1 (high reliability).

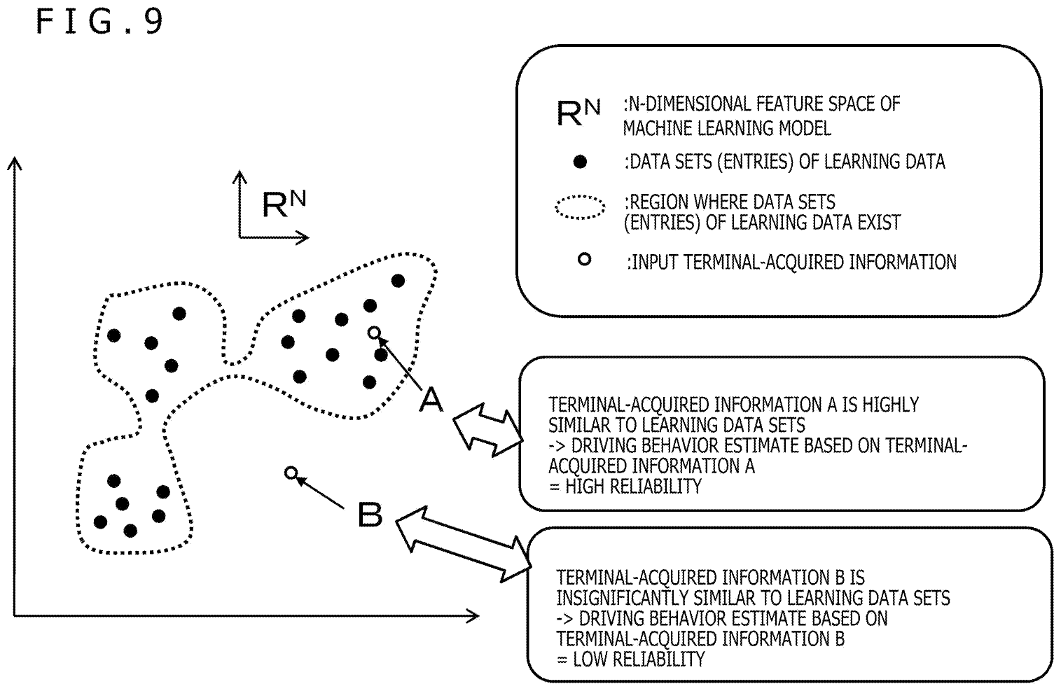

A specific example of the estimation reliability calculation process will be described with reference to FIG. 9.

FIG. 9 illustrates distribution data of data sets (entries) of learning data used to create a learning model. Coordinates are N-dimensional coordinates corresponding to an N-dimensional feature space of a machine learning model.

Black dots correspond to learning data sets (entries). A dotted line frame represents a region where the learning data sets (entries) exist.

It is assumed here, for example, that in the case where the input terminal-acquired information ((a1) to (a7)) is placed in the N-dimensional feature space, one of corresponding points of the terminal-acquired information ((a1) to (a7)) is at a position of a point A.

It is also assumed that another one of the corresponding points of the terminal-acquired information ((a1) to (a7)) is at a position of a point B.

In this case, the point A exists in an N-dimensional space close to the learning data sets (entries) represented by the black dots. That is, the point A exists at a short distance from the learning data sets (entries). In this case, it is possible to perform a highly reliable output, i.e., estimate a driving behavior with high estimation reliability, by using the learning data sets (entries) close to the point A. That is, the reliability (estimation reliability) of the driving behavior information estimated on the basis of the point A is calculated as a large value (close to 1).

Meanwhile, the point B exists in an N-dimensional space far from the learning data sets (entries) represented by the black dots. That is, the point B exists at a long distance from the learning data sets (entries). In this case, even if a learning data set (entry) closest to the point B is used, the similarity between the learning data set (entry) and the point B is low. In this case, a low-reliability output is performed, that is, the driving behavior is estimated with low estimation reliability. That is, the reliability (estimation reliability) of the driving behavior information estimated on the basis of the point B is calculated as a small value (a value close to 0).

(Step S103)

Next, in step S103, the driving behavior estimation section 90 of the management server 30 transmits the driving behavior estimate and the reliability to the user terminal (mobile terminal) and other information usage servers. It should be noted that the transmission data is preferably transmitted in the form of encrypted data.

Examples of the information usage servers include an automobile manufacturer that collects automobile driving behavior data, the police that collect traffic violation information, an insurance company that calculates insurance premiums according to driving behaviors, and the like.

(Step S104)

Finally, in step S104, the driving behavior estimation section 90 of the management server 30 records the driving behavior estimate and the reliability in the DB in association with the attribute data such as date and time of driving, a vehicle type, a driver's ID, and a mobile terminal ID.

### [4. Processes Using a Driving Behavior Estimation Application of the Mobile Terminal]

A description will next be given of processes performed by installing a driving behavior estimation application on the mobile terminal 20 carried by the driver or a passenger of the vehicle 10 and starting the driving behavior estimation application.

Although one of main functions of the driving behavior estimation application in the mobile terminal 20 is the driving behavior estimation process based on the terminal-acquired information, the driving behavior estimation application offers a variety of other functions. A description will be given below of these processes.

It should be noted that, in the case where the driving behavior is estimated on the basis of terminal-acquired information by using the driving behavior estimation application of the mobile terminal 20, any of the following processes is performed.

(1) Information acquired by the mobile terminal 20 is transmitted to the management server 30, and the management server 30 estimates the driving behavior by using a learning model.

(2) The learning model generated by the management server 30 is acquired by the mobile terminal 20, and the mobile terminal 20 calculates a driving behavior estimate on the basis of the terminal-acquired information.

It should be noted that, also in the case where the driving behavior is estimated in mode (2), the mobile terminal 20 also transmits the terminal-acquired information and the driving behavior estimate to the management server 30.

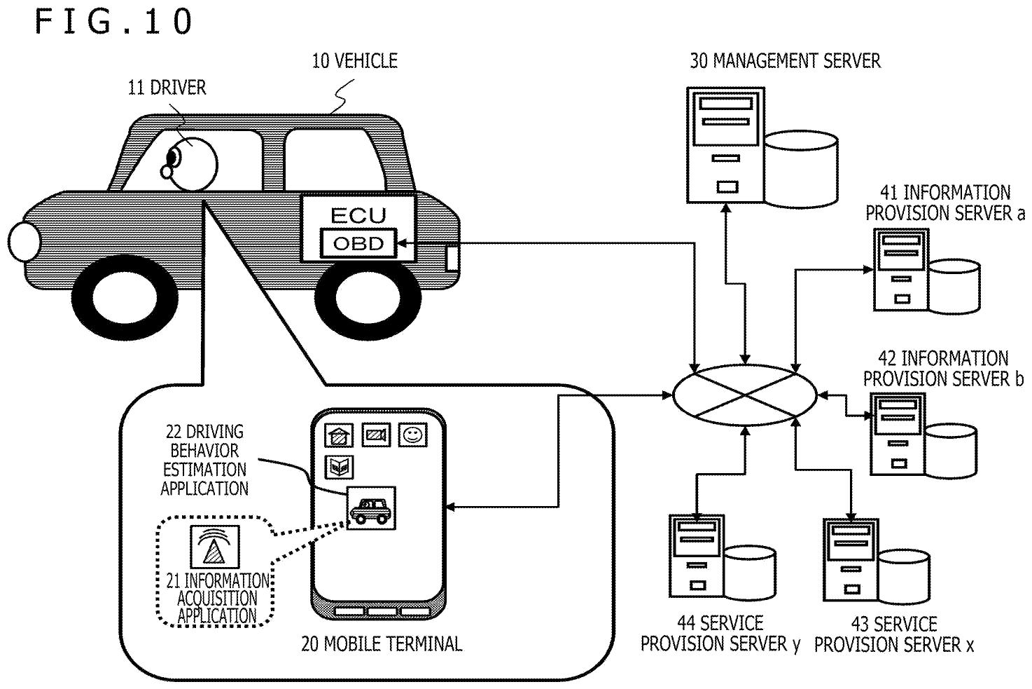

FIG. 10 illustrates a diagram similar to FIG. 1 described earlier. The vehicle 10 is driven by the driver 11. The driver 11 or a passenger, not illustrated, carries a mobile terminal such as a smartphone which is the mobile terminal 20 illustrated in FIG. 10.

The mobile terminal 20 has a driving behavior estimation application 22 installed therein.

The driving behavior estimation application 22 performs a variety of processes for estimating the driving behavior on the basis of terminal-acquired information by applying a learning model. It should be noted that the driving behavior estimation application 22 includes the functions of the information acquisition application 21 described earlier with reference to FIG. 1.

Also, the driving behavior estimation application 22 performs processes such as transmitting terminal-acquired information to the management server 30 and displaying data (e.g., maps and score information) received from the management server 30 or the like. A detailed description will be given below of the processes performed by the driving behavior estimation application 22.

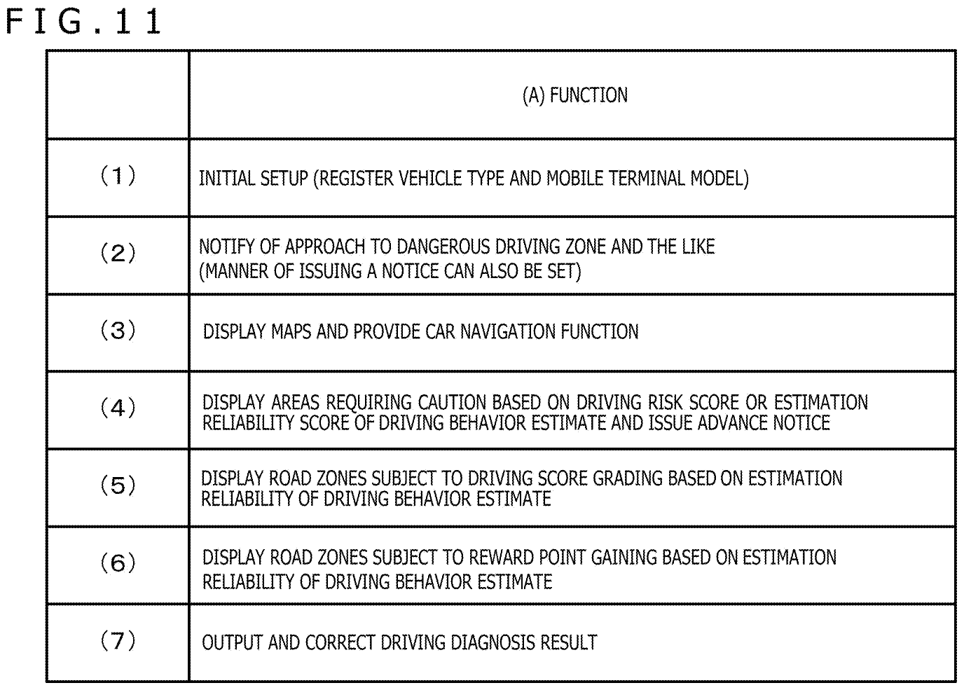

The main functions of the driving behavior estimation application 22 will be described first with reference to FIG. 11.

As illustrated in FIG. 11, the driving behavior estimation application 22 has, for example, the following functions.

(1) initial setup (registration of the vehicle type and the mobile terminal model)

(2) notification of an oncoming dangerous driving zone or the like (manner of giving a notice can also be set)

(3) display of maps and provision of a car navigation function

(4) performance of processes for displaying areas requiring caution such as risky zones on the basis of a driving risk score and a driving reliability score, and giving an advance notice

(5) display of road zones subject to driving score grading on the basis of estimation reliability of the driving behavior estimate

(6) display of road zones subject to reward point gaining on the basis of estimation reliability of the driving behavior estimate

(7) output and correction of driving diagnosis result

The above are examples of the functions available with the driving behavior estimation application 22. These functions will be described in detail in the description of the embodiment given below.

It should be noted that the above functions (1) to (7) include those that use the estimation reliability of the driving behavior estimate and others that do not use the estimation reliability. For example, in the case where the estimation reliability is used, a process is performed using the estimation reliability within the application. Also, some of the functions are restricted from usage by users.

It should be noted that some of the functions that use the estimation reliability become available for use by users by an in-application function release process performed by a service provider after a driving behavior analysis result DB (database) to be described later is created. This will be described in detail later.

A description will be given below of a process to which the driving behavior estimation application 22 is applied, an analysis process using a processing result of the driving behavior estimation application 22, and the like.

These processes will be described in order below.

(Process 1) Download by the User and Initial Setup

First, in the case where the driving behavior estimation application 22 is used on the mobile terminal 20, it is necessary to download the driving behavior estimation application 22 to the mobile terminal 20 and perform an initial setup.

The user of the mobile terminal 20 registers driver information (e.g., sex and age), information of the type of the vehicle to be driven, and further, information of the type of the mobile terminal used. These pieces of registration information are recorded in a database of the management server 30.

(Process 2) Process of Calculating a Driving Behavior Estimate and Prediction Reliability by Applying a Learning Model on the Basis of Terminal-Acquired Information During Vehicle Traveling

When the initial setup is complete following the download of the driving behavior estimation application 22 to the mobile terminal 20, the driving behavior estimation process can be performed using the driving behavior estimation application 22.

That is, when the user carries the mobile terminal 20 and causes the vehicle to travel, the calculation process of the driving behavior estimate and the prediction reliability is performed by applying the learning model on the basis of the terminal-acquired information of the mobile terminal 20.

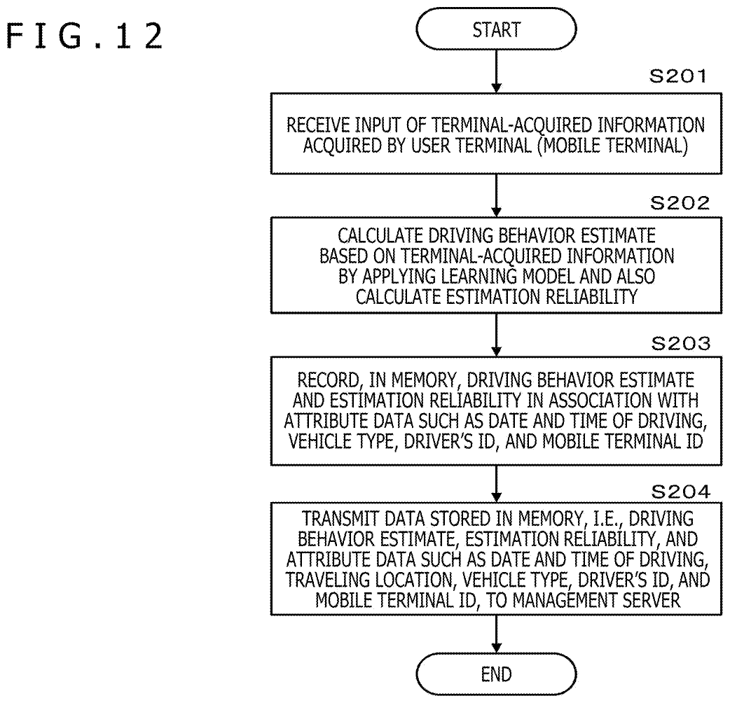

A description will be given of a processing sequence of the driving behavior estimation process performed by the mobile terminal 20 and the management server 30 by using the learning model with reference to a flowchart illustrated in FIG. 12.

It should be noted that the process according to this flow is performed by the driving behavior estimation application 22 of the mobile terminal 20. Processes in the respective steps in the flow illustrated in FIG. 12 will be described in order.

(Step S201)

First, in step S201, the mobile terminal 20 receives input of terminal-acquired information acquired by the mobile terminal 20. The terminal-acquired information includes the following information described earlier with reference to FIG. 2.

(a1) acceleration information

(a2) rotation speed information

(a3) GPS information (e.g., longitude, latitude, and speed information)

(a4) atmospheric pressure information

(a5) azimuth information (traveling direction (e.g., East, West, South, and North))

(a6) terminal operation information

(a7) traffic information

It should be noted that all these pieces of information need not necessarily be received as input and that only some thereof may be received as input.

It should be noted that attribute data such as date and time of driving, a vehicle type, a driver's ID, and a mobile terminal ID is transmitted together with the above terminal-acquired information from the user terminal (mobile terminal), and that the management server acquires these pieces of data and records the data to the DB together with an estimation result to be acquired by the estimation process to be performed next.

(Step S202)

Next, in step S202, the driving behavior estimation application 22 of the mobile terminal 20 calculates a driving behavior estimate on the basis of the terminal-acquired information by applying a learning model and also calculates reliability (estimation reliability) of the calculated driving behavior estimate.

It should be noted that the learning model is used by the mobile terminal 20 in any of the following modes as described earlier.

(1) mode in which the learning model generated by the management server 30 is acquired by the mobile terminal 20 and used after being stored in a memory of the mobile terminal 20

(2) mode in which, in the case where the driving behavior is estimated by the mobile terminal 20, the mobile terminal 20 refers to and use the learning model stored in the management server 30

The driving behavior estimation application 22 of the mobile terminal 20 estimates the driving behavior on the basis of the terminal-acquired information by using the learning model generated by the management server 30 in any of the above modes.

The driving behavior estimation application 22 of the mobile terminal 20 calculates not only the driving behavior estimate but also the estimation reliability of the driving behavior estimate.

(Step S203)

Next, in step S203, the driving behavior estimation application 22 of the mobile terminal 20 records the driving behavior estimate and the reliability in a memory of the mobile terminal 20 in association with the attribute data such as date and time of driving, a vehicle type, a driver's ID, and a mobile terminal ID.

(Step S204)

Finally, in step S204, the driving behavior estimation application 22 of the mobile terminal 20 transmits the data stored in the memory in step S203, i.e., the driving behavior estimate, the reliability, and the attribute data such as date and time of driving, a traveling location, a vehicle type, a driver's ID, and a mobile terminal ID, to the management server. It should be noted that the transmission data is preferably transmitted in the form of encrypted data.

It should be noted that the data transmission process may be performed so as to transmit data one after another or altogether at once every certain time period.

As for the server transmission process in the step S204, data may be transmitted together with score information calculated in the following (processes 3 to 5) as will be further described later in (process 6).

(Process 3) Risk Score Calculation Process Using the Driving Behavior Estimate

A description will next be given of a risk score calculation process using a driving behavior estimate performed by the driving behavior estimation application 22 of the mobile terminal 20.

The driving behavior estimation application 22 of the mobile terminal 20 calculates a risk score that is an index representing a degree of driving risk of the user (driver) by using the driving behavior estimate calculated in the above (process 2).

The driving behavior estimation application 22 calculates a risk score Dt at time t in accordance with the following calculation formula (Formula 1):

Dt=f_{D}(d₁ₜ,d₂ₜ, . . . ,dₘₜ)) (Formula 1),

where f_{D} is a risk score calculation function, and

d₁ₜ, d₂ₜ, . . . , dₘₜ are a set of driving behavior estimates calculated by applying the learning model. Specifically, these are a data set of driving behavior estimates at a certain time (t) estimated on the basis of terminal-acquired information at the time (t). Each of the values included in the data set is, for example, one of a variety of driving behavior information estimates such as (b1) to (b3) illustrated in FIG. 4.

It should be noted that the risk score calculation function f_{D} is designed by a service operator such that the more dangerous the behavior of the driver, the larger the risk score calculation function f_{D}. Specifically, for example, the risk score calculation function f_{D} is calculated with a weighted mean of the driving behavior estimates or the like as indicated in the following (Formula 2):

Dt=f_{D}(d₁ₜ,d₂ₜ, . . . ,dₘₜ))=w₁d₁ₜ+w₂d₂ₜ+ . . . +wₘdₘₜ (Formula 2)

where wᵢ(i=1, . . . , m) is a weighting factor.

(Process 4) Reliability Score Calculation Process Using the Driving Behavior Estimate

A description will next be given of a reliability score calculation process using a driving behavior estimate performed by the driving behavior estimation application 22 of the mobile terminal 20.

The driving behavior estimation application 22 of the mobile terminal 20 calculates a reliability score that is an index value of overall estimation reliability of the driving behavior estimate calculated at a certain time (t), by using the driving behavior estimate and the estimation reliability calculated in the above (process 2).

The driving behavior estimation application 22 calculates a reliability score Rt at time t in accordance with the following calculation formula (Formula 3):

Rt=f_{R}(r₁ₜ,r₂ₜ, . . . ,rₘₜ)) (Formula 3)

where f_{R} is a reliability score calculation function, and

r₁ₜ, r₂ₜ, . . . , rₘₜ are a set of estimation reliabilities corresponding to the driving behavior estimate calculated by applying the learning model. Specifically, these are a data set of estimation reliabilities corresponding to the driving behavior estimate at a certain time (t) estimated on the basis of terminal-acquired information at the time (t). Each of the values included in the data set is, for example, the estimation reliability corresponding to one of a variety of driving behavior information estimates such as (b1) to (b3) illustrated in FIG. 4.

It should be noted that the reliability score calculation function f_{R} is designed by a service operator such that the higher the estimation reliability of the driving behavior estimate calculated by applying the learning mode, the larger the reliability score calculation function f_{R}. Specifically, for example, the reliability score calculation function f_{R} is calculated with a weighted mean of the estimation reliabilities or the like as indicated in the following (Formula 4):

$$\begin{matrix}Rt = {f}_{R} ( {r}_{1 t} , {r}_{2 t} , … , {r}_{mt} ) ) \\ = {v}_{1} {r}_{1 t} + {v}_{2} {r}_{2 t} + … + {v}_{m} {r}_{mt}\end{matrix} \qquad ( Formula 4 )$$

where vᵢ(i=1, . . . , m) is a weighting factor.

(Process 5) Overall Score Calculation Process Using the Risk Score and the Reliability Score

A description will next be given of an overall score calculation process using the risk score and the reliability score performed by the driving behavior estimation application 22 of the mobile terminal 20.

An overall score representing a driving diagnosis result of the driver is calculated by using the risk score calculated by the above (process 3) and the reliability score calculated by the above (process 4).

The driving behavior estimation application 22 calculates an overall score St at time t in accordance with the following calculation formula (Formula 5):

Sₜ=f_{S}(Rₜ,Dₜ) (Formula 5)

where fₛ is an overall score calculation function,

Rₜ is a reliability score at time t, and

Dₜ is a risk score at time t.

The function fₛ is designed by a service operator. For example, as the function fₛ, a function that calculates a product of the reliability score Rₜ and the risk score Dₜ to perform normalization such that the product falls within the range of 0 to 100 can be applied as indicated in the following (Formula 6):

$$\begin{matrix}{S}_{t} = {f}_{s} ( {R}_{t} , {D}_{t} ) \\ = min ( 0 , max ( 100 , ( {R}_{t} \cdot {D}_{t} ) / Z ) )\end{matrix} \qquad ( Formula 6 )$$

where Z is a normalization constant.

This calculation formula is merely an example, and various other computation processes can also be used.

By calculating the overall score Sₜ in accordance with the above (Formula 6), it is possible to calculate, for example, an overall score in the range of 0 to 100 points according to the degree of driving risk of the user (driver).

The lower the driving risk of the user (driver), the closer the overall score is to 100 points, and the higher the driving risk of the user (driver), the closer the overall score is to 0 point.

(Process 6) Process of Transmitting the Driving Behavior Estimate and the Calculated Scores to the Management Server

A description will next be given of a process of transmitting the driving behavior estimate and the calculated scores to the management server performed by the driving behavior estimation application 22 of the mobile terminal 20.

The driving behavior estimation application 22 of the mobile terminal 20 calculates the following data in the above (process 2) to (process 5) and stores the data in the memory.

(1) driving behavior estimate

(2) estimation reliability

(3) risk score

(4) reliability score

(5) overall score

Hereinafter, these pieces of data (1) to (5) will be collectively referred to as a “driving behavior analysis result.”

The “driving behavior analysis result” that includes the above pieces of data (1) to (5) is stored first in the memory of the mobile terminal 20.

Further, the driving behavior estimation application 22 of the mobile terminal 20 transmits, to the management server, not only the data stored in the memory, i.e., the “driving behavior analysis result” that includes the above pieces of data (1) to (5) but also attribute data such as date and time of driving, a traveling location, a vehicle type, a driver's ID, and a mobile terminal ID. It should be noted that the transmission data is preferably transmitted in the form of encrypted data. It should be noted that the data transmission process may be performed so as to transmit data one after another or altogether at once every certain time period.

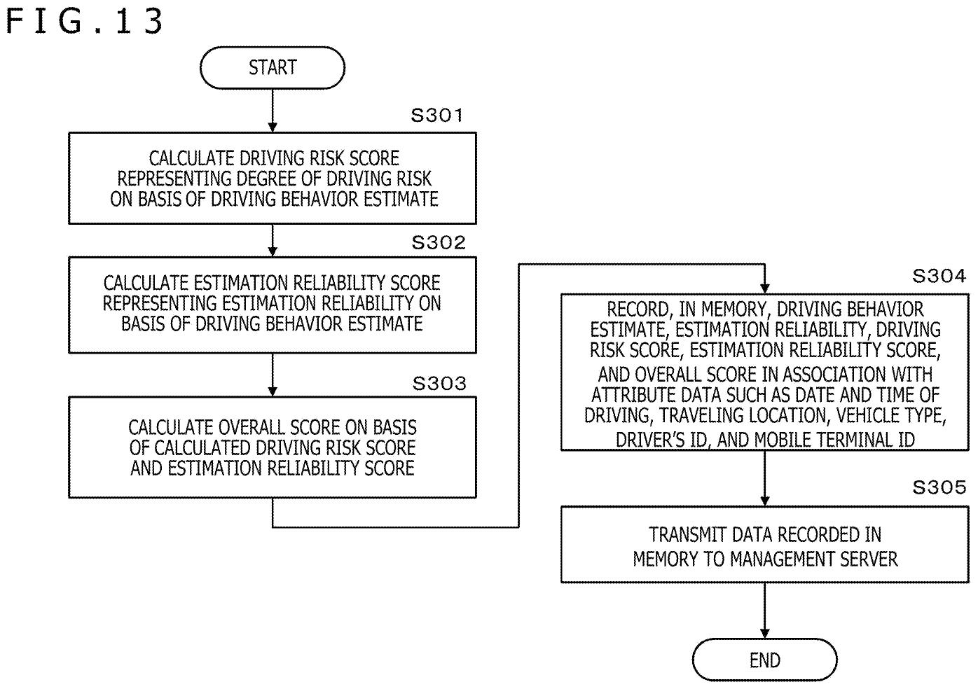

A description will be given of a processing sequence of the above (process 3) to (process 6) with reference to a flowchart illustrated in FIG. 13. The flowchart illustrated in FIG. 13 describes a processing sequence of a score calculation process using a driving behavior estimation result.

Processes in the respective steps of the flowchart in FIG. 13 will be described below.

(Step S301)

First, in step S301, the driving behavior estimation application 22 of the mobile terminal 20 calculates a driving risk score representing the degree of driving risk on the basis of the driving behavior estimate.

This process is a process of calculating the risk score Dₜ described in the above (process 3).

(Step S302)

Next, in step S302, the driving behavior estimation application 22 calculates a reliability score on the basis of the driving behavior estimate and the estimation reliability.

This process is a process of calculating the reliability score Rt described in the above (process 4).

(Step S303)

Next, in step S303, the driving behavior estimation application 22 calculates the overall score St for driving diagnosis by using the risk score Dt calculated in step S301 and the reliability score Rt calculated in step S302.

This process is a process of calculating the overall score Sₜ described in the above (process 5).

(Step S304)

Next, in step S304, the driving behavior estimation application 22 records the driving behavior estimate, the estimation reliability, the driving risk score, the estimation reliability score, and the overall score to the memory in association with attribute data such as date and time of driving, a traveling location, a vehicle type, a driver's ID, and a mobile terminal ID.

(Step S305)

Next, in step S305, the driving behavior estimation application 22 transmits the data stored in the memory in step S304 to the management server.

That is, the driving behavior estimation application 22 transmits, to the management server 30, the driving behavior estimate, the estimation reliability, the driving risk score, the estimation reliability score, the overall score, and the attribute data such as date and time of driving, a traveling location, a vehicle type, a driver's ID, and a mobile terminal ID.

The processes in steps S304 and S305 are described in the above (process 6).

(Process 7) Driving Behavior Analysis Result Database Creation Process

A description will next be given of a driving behavior analysis result database creation process performed by the management server 30 as process 7.

The management server 30 receives the “driving behavior analysis result” described in the above (process 6) and the associated attribute data (e.g., date and time of driving, a traveling location, a vehicle type, a driver's ID, and a mobile terminal ID) from a plurality of users.

The management server 30 creates a driving behavior analysis result DB (database) on the basis of the received data.

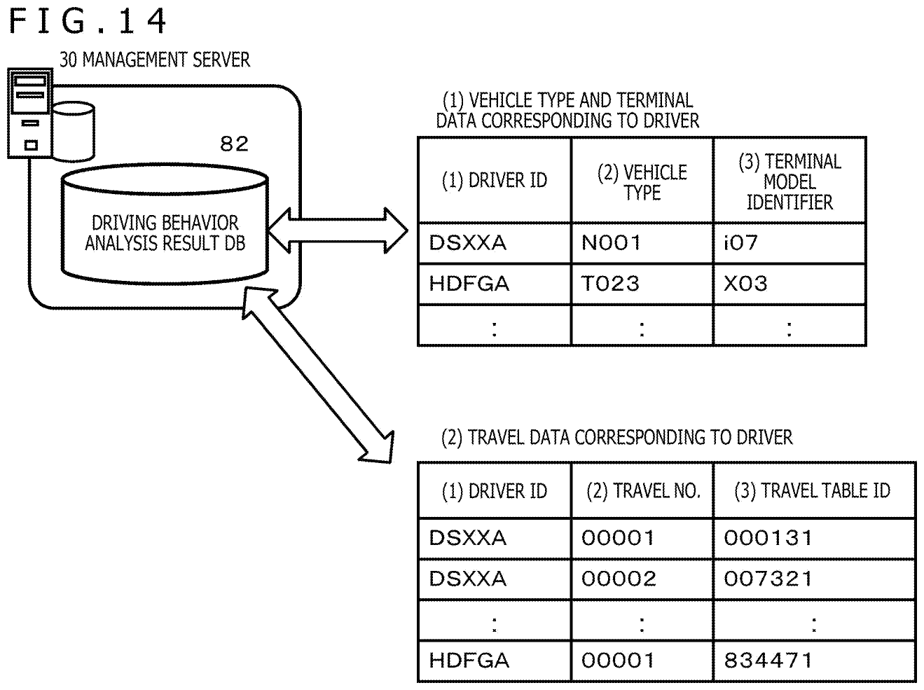

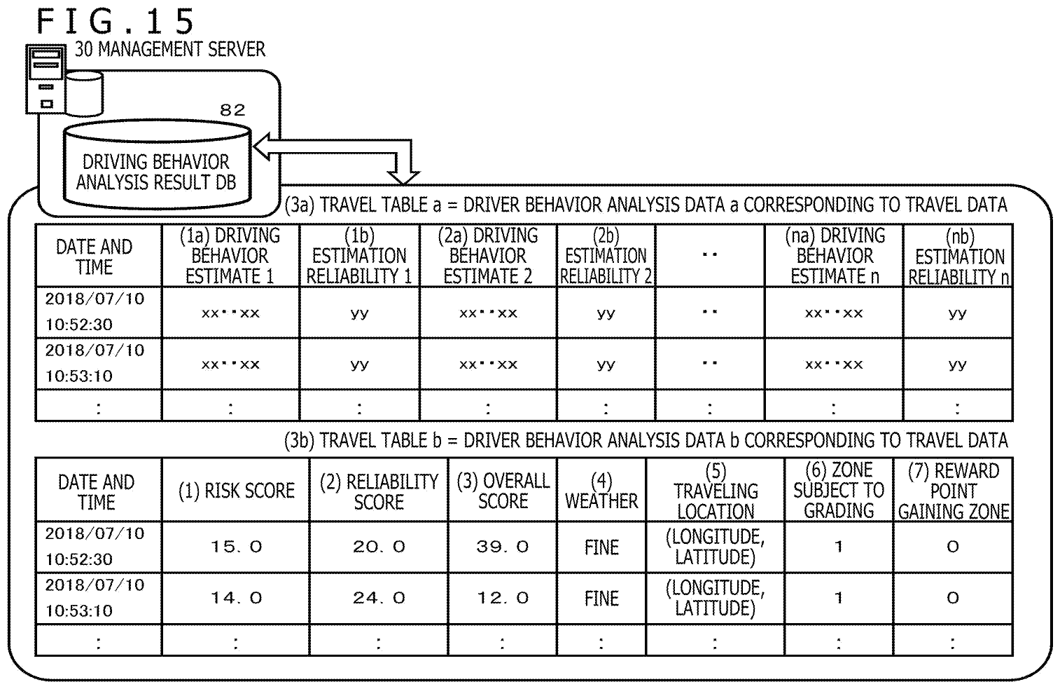

A description will be given of data stored in a driving behavior analysis result DB (database) 82 generated by the management server 30 with reference to FIGS. 14 and 15.

The driving behavior analysis result DB (database) 82 of the management server 30 stores not only (1) vehicle type and terminal data corresponding to driver and (2) travel data corresponding to driver illustrated in FIG. 14 but also (3) driver behavior information analysis data corresponding to travel data illustrated in FIG. 15.

Vehicle type information and mobile terminal information for each driver (for each driver ID) are recorded as vehicle type and terminal data corresponding to driver in (1) illustrated in FIG. 14. These pieces of information are acquired at the time of initial setup of the driving behavior estimation application 22 by each user and registered.

Also, a travel number and a travel table ID are recorded as travel information for each driver ID as travel data corresponding to driver in (2) illustrated in FIG. 14. The travel number and the travel table ID are assigned automatically by the driving behavior estimation application 22 for each unit of traveling, for example, in the case where the user (driver) performs a traveling process while executing the driving behavior estimation application 22.

It should be noted that one unit of traveling is, for example, a time period from when the user starts an engine to when he or she stops the engine. It is also possible to set one unit of traveling to a time period from when the user starts the driving behavior estimation application 22 to when he or she stops the driving behavior estimation application 22.

For each travel table ID, driver behavior analysis data corresponding to travel data in (3) illustrated in FIG. 15 is generated and stored in the database.

The driver behavior analysis data corresponding to travel data in (3) illustrated in FIG. 15 includes two tables.

Driver behavior analysis data ‘a’ corresponding to travel data in (3a) is a table that has recorded therein correspondence data between a plurality of driving behavior estimates and a plurality of estimation reliabilities calculated by applying the learning model on the basis of the terminal-acquired information.

Driver behavior analysis data ‘b’ corresponding to travel data in (3b) is a table that has recorded therein not only (1) a risk score, (2) a reliability score, and (3) an overall score calculated on the basis of the driving behavior estimates and the estimation reliabilities recorded in the driver behavior analysis data ‘a’ corresponding to travel data in (3a) but also the following pieces of information.

(4) weather and (5) traveling location: traveling conditions during traveling subject to score calculation (weather, traveling location)

(6) zone subject to grading: information representing whether or not the traveling location is within a zone subject to grading of the user's (driver's) driving behavior, where 1 means a zone subject to grading and 0 means a zone not subject to grading.

(7) reward gaining zone: information representing whether or not the traveling location is within a zone subject to grading of the user's (driver's) driving behavior, where 1 means a reward gaining zone and 0 means not a reward gaining zone.

(Process 8) Process of Analyzing Scores, Category-by-Category, for Data Stored in the Driving Behavior Analysis Result Database

A description will next be given of a process of analyzing scores, category-by-category, for data stored in the driving behavior analysis result database 82 performed by the management server 30 as process 8.

The management server 30 performs the score analysis process for each category by using data stored in the driving behavior analysis result database 82 that has stored data described with reference to FIGS. 14 and 15.

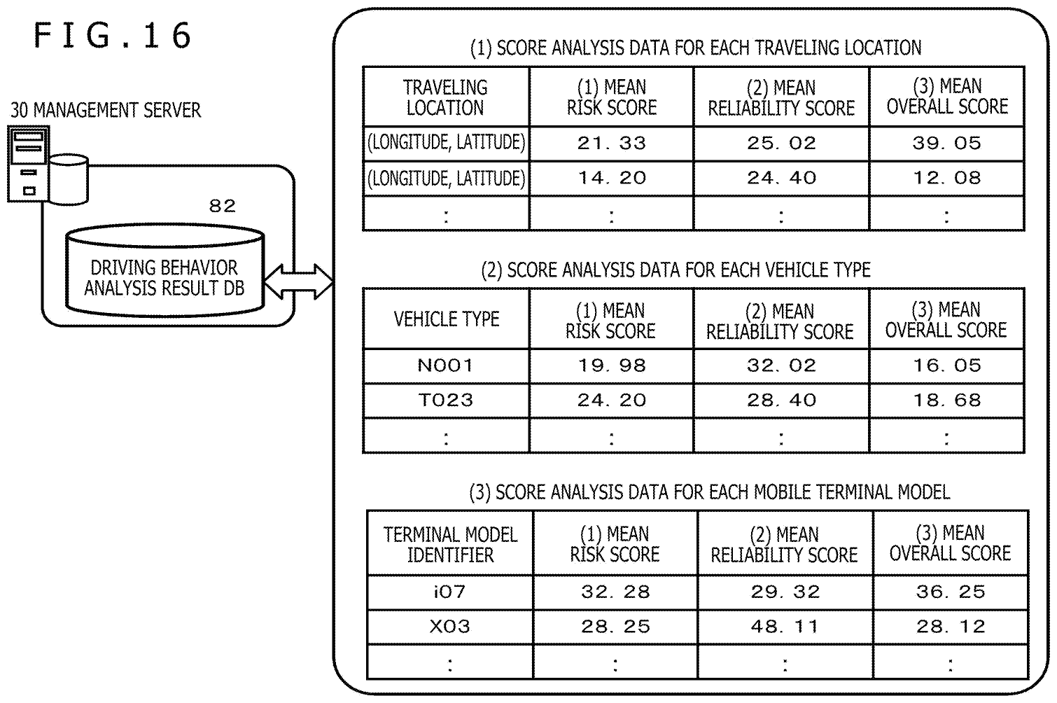

Specifically, category-by-category score analysis data as follows is generated, for example, as illustrated in FIG. 16.

(1) analysis data of scores (risk score, reliability score, overall score) for each traveling location

(2) analysis data of scores (risk score, reliability score, overall score) for each vehicle type

(3) analysis data of scores (risk score, reliability score, overall score) for each mobile terminal model

It should be noted that these pieces of score data are also stored in the driving behavior analysis result database 82.

As illustrated in FIG. 16, the score analysis data for each traveling location in (1) is a table that stores mean data (statistics) of the risk score, reliability score, and overall score corresponding to each traveling location. The mean scores are derived by calculating means of data received from mobile terminals in a plurality of vehicles.

Also, the score analysis data for each vehicle type in (2) is a table that stores mean data (statistics) of the risk score, reliability score, and overall score corresponding to each vehicle type.

The score analysis data for each mobile terminal model in (3) is a table that stores mean data (statistics) of the risk score, reliability score, and overall score corresponding to each mobile terminal model.

It should be noted that although only the traveling location, the vehicle type, and the mobile terminal model are indicated as categories in the example illustrated in FIG. 16, it is possible to generate analysis data for each of various categories such as driver's information including sex and age, a driving time period, the weather, and the like.

Also, although means are calculated as statistics of scores in the example illustrated in FIG. 16, various values such as medians and variances of scores can be used as statistics.

(Process 9) Process of Setting Road Zones on the Basis of Category-by-Category Score Analysis Data

A description will next be given of a process of setting road zones on the basis of category-by-category score analysis data performed by the management server 30.

“(1) Score analysis data for each traveling location” is acquired from the category-by-category score analysis data generated in the above (process 8), and then statistics (e.g., means) of the reliability score and the overall score for each set of longitude and latitude coordinates (x, y) of a traveling location are assumed to be

reliability score statistic=R_{place}(x,y) and

overall score statistic=S_{place}(x,y),respectively.

Search is made for location groups A_{check} and A_{danger} where the reliability score statistic R_{place}(x, y) and the overall score statistic S_{place}(x, y) are larger than thresholds Rₜₕᵣₑₛ and Sₜₕᵣₑₛ prescribed in advance, respectively.

Specifically, search is made for a location that satisfies

reliability score statistic>reliability score threshold, i.e.,

R_{place}(x,y)>Rₜₕᵣₑₛ

as a to-be-checked location A_{check}.

The to-be-checked location A_{check} found by this search process is set as a “road zone subject to driving score grading.”

Also, search is made for a location that satisfies overall score statistic>overall score threshold, i.e.,

S_{place}(x,y)>Sₜₕᵣₑₛ

as a risky location A_{danger}.

The risky location A_{danger} found by this search process is set as a “road zone where dangerous driving has occurred.”

Further, search is made for a location group A_{reward} where the reliability score statistic R_{place}(x, y) is smaller than a reward point threshold R2ₜₕᵣₑₛ prescribed in advance.

Specifically, search is made for a location that satisfies

reliability score statistic<reward point threshold, i.e.,

R_{place}(x,y)<R2ₜₕᵣₑₛ

as a reward point granting location A_{reward}.

The reward point granting location A_{reward} found by this search process is set as a “road zone subject to reward point gaining.”

The management server 30 stores, in a map information database managed by the management server 30, the following pieces of zone information.

(1) road zones subject to driving score grading

(2) road zones where dangerous driving has occurred

(3) road zones subject to reward point gaining

Information in the map information database is released to the user on the basis of the decision made by the management server 30.

It should be noted that the following zones are expressed by the following formula (Formula 7).

(1) road zones subject to driving score grading: A_{check}

(2) road zones where dangerous driving has occurred: A_{danger}

(3) road zones subject to reward point gaining: A_{reward}

A_{check}={(x,y)|R_{place}(x,y)>Rₜₕᵣₑₛ}

A_{danger}={(x,y)|S_{place}(x,y)>Sₜₕᵣₑₛ}

A_{reward}={(x,y)|R_{place}(x,y)<R2ₜₕᵣₑₛ} Formula 7)

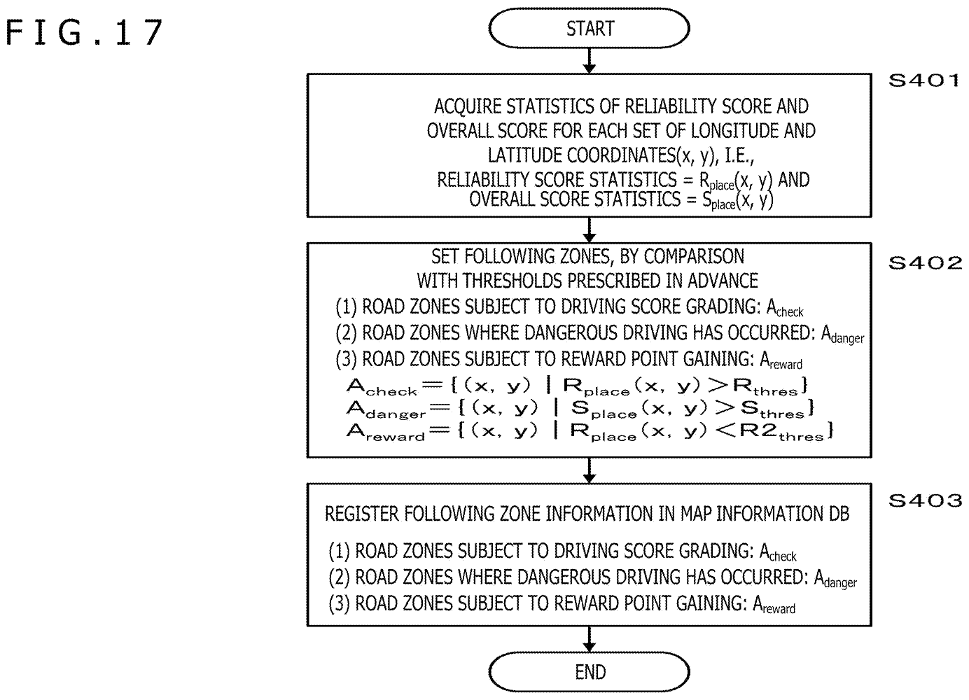

FIG. 17 illustrates a flowchart indicating the procedure of this (process 9).

A description will be given of processes of the respective steps in the flow illustrated in FIG. 17.

(Step S401)

First, in step S401, the management server 30 acquires statistics of the reliability score and the overall score for each set of longitude and latitude coordinates (x, y) of a traveling location, i.e.,

reliability score statistic=R_{place}(x,y) and

overall score statistic=S_{place}(x,y).

(Step S402)

Next, in step S402, the management server 30 sets the following zones by comparison with thresholds prescribed in advance.

(1) road zones subject to driving score grading: A_{check}

(2) road zones where dangerous driving has occurred: A_{danger}

(3) road zones subject to reward point gaining: A_{reward}

That is, the respective zones are defined by the following formulas as described above.

A_{check}={(x,y)|R_{place}(x,y)>Rₜₕᵣₑₛ}

A_{danger}={(x,y)|S_{place}(x,y)>Sₜₕᵣₑₛ}

A_{reward}={(x,y)|R_{place}(x,y)<R2ₜₕᵣₑₛ}

(Step S403)

Next, in step S403, the management server 30 registers the following pieces of zone information in the map informant DB.

(1) road zones subject to driving score grading: A_{check}

(2) road zones where dangerous driving has occurred: A_{danger}

(3) road zones subject to reward point gaining: A_{reward}

It should be noted that the information in this map information database is released to the user on the basis of the decision made by the management server 30 as described earlier.

As described above, the management server 30 calculates statistics of the risk score, reliability score, and overall score corresponding to a variety of vehicle types, models, locations, weathers, and dates and times on the basis of a plurality of pieces of travel data and further sets each of the above zones on the basis of the statistics.

Zone setting information can be referred to by the user via the mobile terminal 20.

[5. Processes Using the Driving Behavior Estimation Application after Creating the Driving Behavior Analysis DB]

A description will next be given of processes performed by the user (e.g., driver) using the driving behavior estimation application installed in the mobile terminal 20 after the creation of the driving behavior analysis DB 82 by the management server 30.

A description will be given of the following items in order:

(1) Process before start of traveling by use of the driving behavior estimation application

(2) Process during traveling by use of the driving behavior estimation application

(3) Process after traveling by use of the driving behavior estimation application

### [5-(1) Process Before Start of Traveling by Use of the Driving Behavior Estimation Application]

A description will be given first of a process performed before start of traveling by use of the driving behavior estimation application.

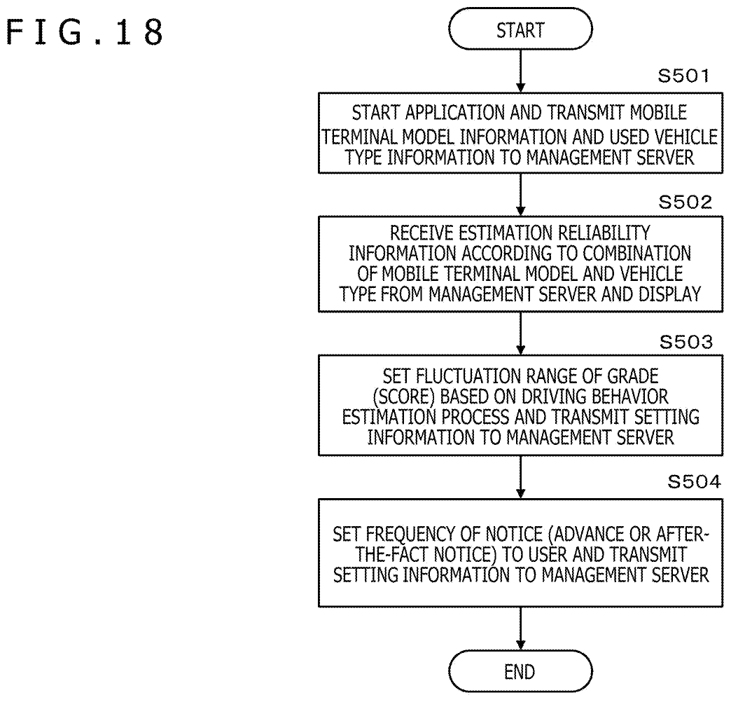

A description will be given of a processing sequence before start of traveling by use of the driving behavior estimation application 22 performed by the mobile terminal 20 with reference to a flowchart illustrated in FIG. 18.

(Step S501)

First, in step S501, the user of the mobile terminal 20 starts the driving behavior estimation application 22 already installed in the mobile terminal 20, displays an initial screen, enters mobile terminal model information and used vehicle type information, and transmits these pieces of information to the management server 30.

(Step S502)

Next, in step S502, the mobile terminal 20 receives estimation reliability information ( ) corresponding to a combination of the mobile terminal model information and the used vehicle type information entered in step S501 from the management server 30 and displays the estimation reliability information on the mobile terminal 20.

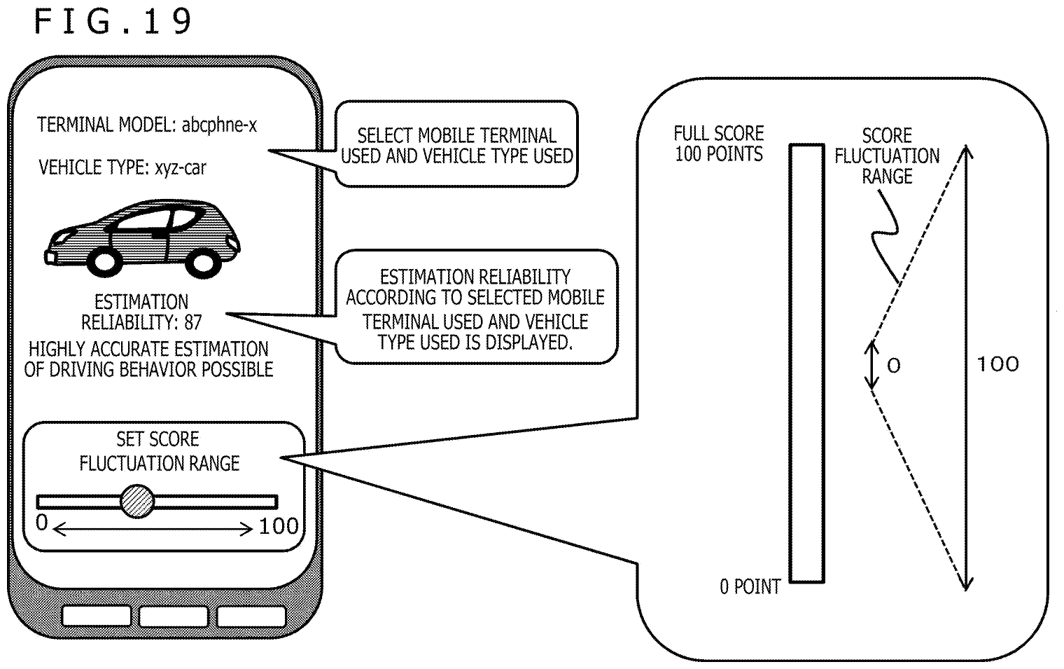

FIG. 19 illustrates an example of a screen displayed on the mobile terminal 20.

Terminal model: abcpohne-x

Vehicle type: xyz-czr

The above pieces of information are the mobile terminal model information and the used vehicle type information entered by the user in step S501.

Estimation reliability: 87, (comment=highly accurate estimation of driving behavior possible)

This is the estimation reliability information received from the management server 30 in step S502 and corresponds to the combination of the mobile terminal model information and the used vehicle type information entered by the user.

Further, a comment according to the value of the estimation reliability is transmitted from the management server 30 and displayed on the mobile terminal 20 as a comment.

The estimation reliability of 87 is relatively high, allowing highly reliable estimation of the driving behavior because of the combination of the user's mobile terminal model and used vehicle type. A comment notifying the user of this fact is provided by the management server 30.

It should be noted that the estimation reliability information corresponding to the combination of the mobile terminal model information and the used vehicle type information is data stored in the driving behavior analysis DB 82 managed by the management server 30.

The management server 30 performs the driving behavior estimation processes according to a variety of mobile terminal models and vehicle types, generating the estimation reliability information corresponding to the combinations of the mobile terminal model information and the used vehicle type information on the basis of a verification result of this data and storing the information in the driving behavior analysis DB 82.

In step S502, this data is provided from the management server 30 to the mobile terminal 20 for display on the mobile terminal 20.

(Step S503)

Next, in step S503, the user of the mobile terminal 20 sets a grade (score) fluctuation range on the basis of the driving behavior estimation process and transmits the setting information to the management server 30.

As described earlier with reference to FIGS. 13 to 16, the management server 30 calculates the driving behavior estimate on the basis of the terminal-acquired information and calculates various scores on the basis of the driving behavior estimate. That is, (1) risk score, (2) reliability score, and (3) overall score, are calculated.

Here, (1) risk score and (3) overall score are scores that can be used as indices representing user's (driver's) safe driving level, and these scores can be used for a variety of services such as insurance premium calculation and point granting.

Specifically, (1) risk score and (3) overall score are provided to an insurance company, for example, for charge calculations such that, if the insurance company estimates that the user (driver) safely drives in a non-dangerous manner, he or she will be charged a low insurance premium.

As described earlier, the overall score is calculated, for example, to fall within a range of 0 to 100 points by the computation process based on the risk score and the reliability score. Zero point corresponds to dangerous driving whereas 100 points correspond to safe driving.

However, although this score (overall score) is highly reliable when the estimation reliability is high, it is less reliable when the estimation reliability is lower.

The user sets a score fluctuation range in consideration of this factor. In the case where the score fluctuation range set by the user is small, the score (overall score) calculated by the computation process based on the risk score and the reliability score remains at a mean value such as in the vicinity of 50 points.

Meanwhile, in the case where the score fluctuation range set by the user is large, there is a possibility that the score (overall score) calculated by the computation process based on the risk score and the reliability score may have a value fluctuating significantly between 0 and 100 points.

Accordingly, a user confident in driving can set a large fluctuation range for score calculation such that a high grade can be acquired. It should be noted, however, that this may conversely lead to a low grade if the user has bad driving behavior.

In contrast, a user not confident in driving can expect a stable score by reducing the fluctuation range of the grade.

(Step S504)

Next, in step S504, the user of the mobile terminal 20 sets frequencies of notices given to the user (advance notice and after-the-fact notice) and transmits the setting information to the management server 30.

Examples of notices given to the user include advance notices such as oncoming “road zone where dangerous driving has occurred” and after-the-fact notices such as warning against user's driving behavior decided dangerous on the basis of the driving behavior estimate, for example, an abrupt braking action.

The user can set frequencies of the notices.

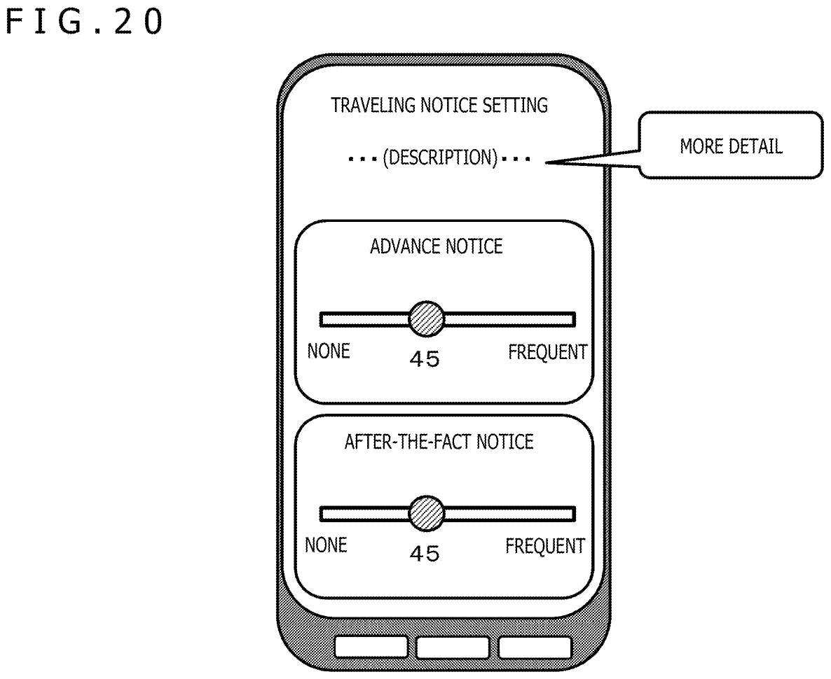

FIG. 20 illustrates an example of a screen for setting frequencies of notices.

As illustrated in FIG. 20, the user can set a frequency of advance notices and a frequency of after-the-fact notices separately.

This setting information is transmitted to the management server 30, after which the management server 30 decides whether or not to give a notice to the user on the basis of the setting information and performs a process of notifying the user according to the decision result.

### [5-(2) Process During Traveling by Use of the Driving Behavior Estimation Application]

A description will next be given of a process performed during traveling by use of the driving behavior estimation application.

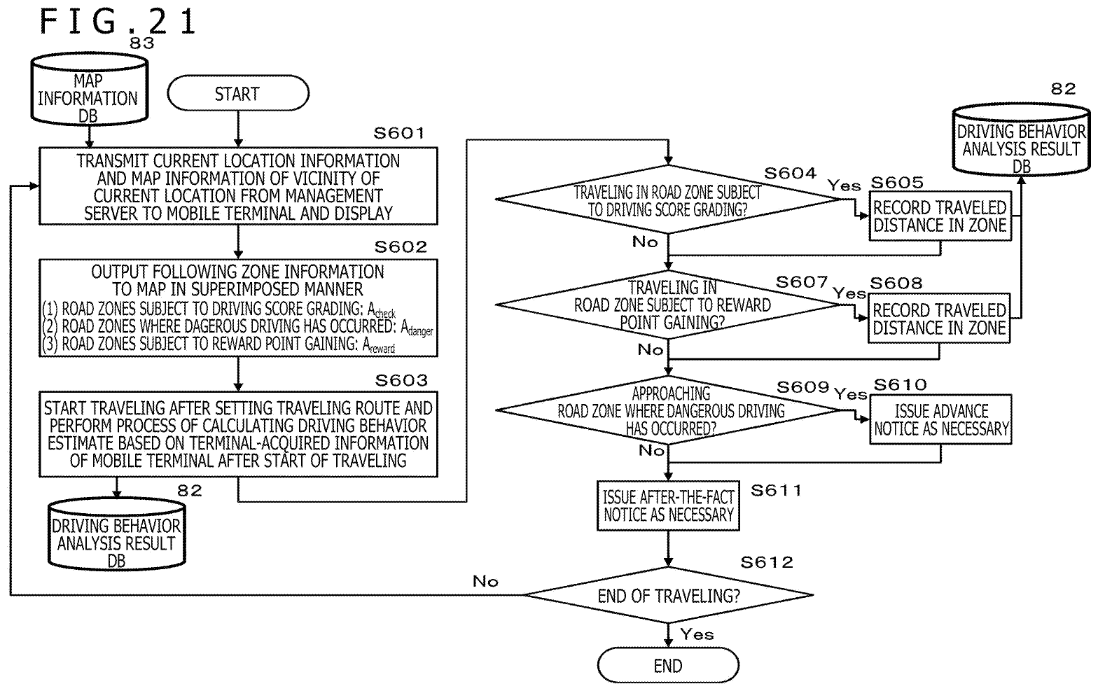

A description will be given of a processing sequence during traveling by use of the driving behavior estimation application 22 performed by the mobile terminal 20 with reference to a flowchart illustrated in FIG. 21.

Processes in the respective steps of the flow illustrated in FIG. 21 will be described in order.

(Step S601)

First, in step S601, current location information and map information of a vicinity of the current location are transmitted from the management server 30 to the mobile terminal 20 for display on a display section of the mobile terminal 20. The management server 30 has a map information DB 83, acquiring a map including the vicinity of the current location from the map information DB 83 on the basis of the current location information received from the mobile terminal 20 and transmitting the map to the mobile terminal 20 for display on the display section.

(Step S602)

Further, the management server 30 displays the following pieces of road zone information in a superimposed manner on the map information displayed on the mobile terminal 20.

(1) road zones subject to driving score grading: A_{check}

(2) road zones where dangerous driving has occurred: A_{danger}

(3) road zones subject to reward point gaining: A_{reward}

It should be noted that, as described earlier, these pieces of road zone information are registered in the map information DB 83 managed by the management server 30.

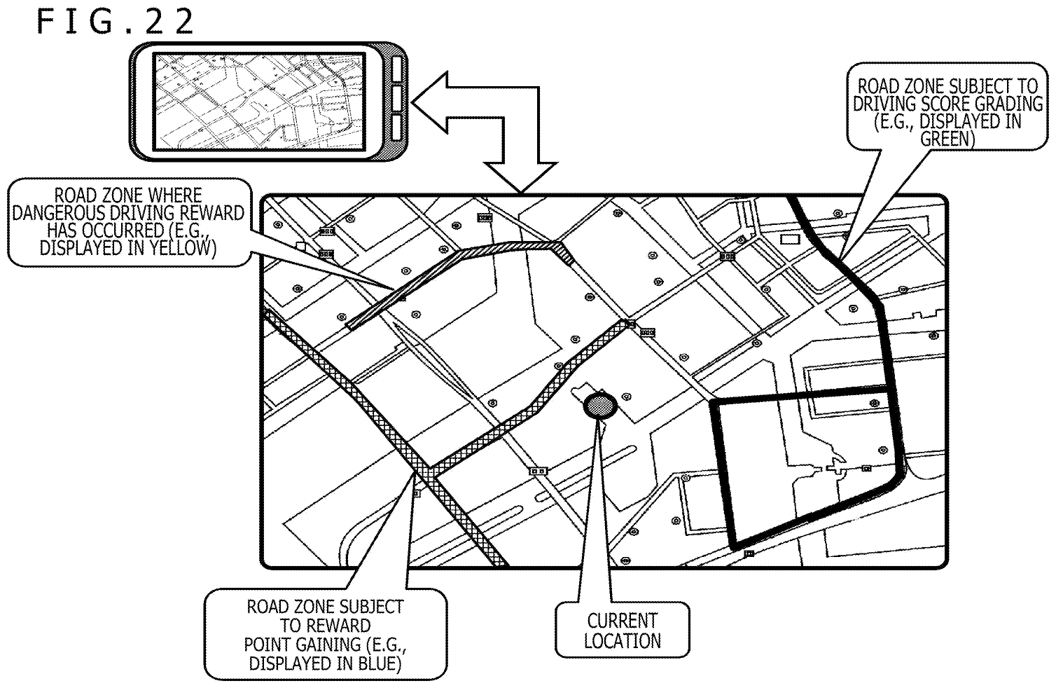

FIG. 22 illustrates an example of data displayed on the display section of the mobile terminal 20 after the process in step S602.

As illustrated in FIG. 22, a map including the current location is displayed on the display section of the mobile terminal 20, and further, the following three kinds of road zone information are displayed on the roads of the map in a manner distinguishable from each other.

(1) road zones subject to driving score grading: A_{check}

(2) road zones where dangerous driving has occurred: A_{danger}

(3) road zones subject to reward point gaining: A_{reward}

(Step S603)

Next, in step S603, the user (driver) starts traveling after setting a traveling route. After the traveling begins, a process is started to calculate a driving behavior estimate on the basis of the terminal-acquired information of the mobile terminal 20.

It should be noted that the driving behavior estimate calculation process based on the terminal-acquired information is performed in any of the following modes.

(1) mode in which acquired information of the mobile terminal 20 is transmitted to the management server 30, after which the management server 30 estimates the driving behavior by using the learning model

(2) mode in which the mobile terminal 20 acquires the learning model generated by the management server 30, after which the mobile terminal 20 calculates a driving behavior estimate on the basis of the terminal-acquired information

It should be noted that, even in the case where the driving behavior is estimated in mode (2), the mobile terminal 20 transmits the terminal-acquired information and the driving behavior estimate to the management server 30.

The server 30 records, in the driving behavior analysis result DB 82, acquired information including the terminal-acquired information, the driving behavior estimate based on the terminal-acquired information, the estimation reliability, and other information.

(Steps S604 and S605)

In step S604 after the traveling begins, a decision is made as to whether or not the vehicle is traveling in a road zone subject to driving score grading.

If it is decided that the vehicle is traveling in a road zone subject to driving score grading, a traveled distance in the road zone is recorded in the driving behavior analysis result DB 82.

Not only acquired information including the terminal-acquired information, the driving behavior estimate based on terminal-acquired information, the estimation reliability, and other information but also the traveled distance in the road zone subject to driving score grading are recorded in the driving behavior analysis result DB 82.

At the time of driving score calculation, the score is calculated in consideration of the traveled distance.

(Steps S606 and S607)

Further, in step S606, a decision is made as to whether or not the vehicle is traveling in a road zone subject to reward point gaining.

If it is decided that the vehicle is traveling in a road zone subject to reward point gaining, a traveled distance in the road zone is recorded in the driving behavior analysis result DB 82.

Not only acquired information including the terminal-acquired information, the driving behavior estimate based on the terminal-acquired information, the estimation reliability, and other information but also the traveled distance in the road zone subject to reward point gaining are recorded in the driving behavior analysis result DB 82.

At the time of reward point calculation, the reward point is calculated in consideration of the traveled distance.

(Steps S609 to S611)

Further, in step S609, a decision is made as to whether or not the vehicle is approaching a road zone where dangerous driving has occurred.

In the case where it is decided that the vehicle is approaching a road zone where dangerous driving has occurred, the user is notified in step S610 via the mobile terminal 20 as necessary that the vehicle is approaching a risky road. It should be noted that this notice is given in consideration of a level (frequency) set by the user.

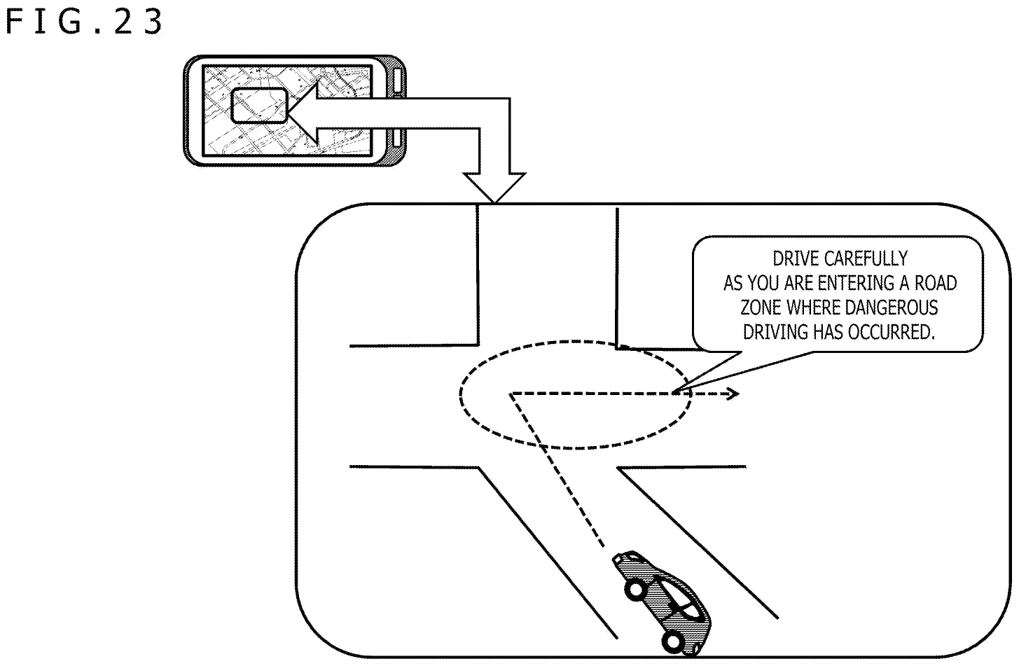

FIG. 23 illustrates an example of the notification process. As illustrated in FIG. 23, in the case where it is decided that the vehicle is approaching a road zone where dangerous driving has occurred, the user is notified that the vehicle is approaching a risky road.

In the case where it is decided that the vehicle is not approaching any road zone where dangerous driving has occurred, an after-the-fact notice is given, as necessary, in step S611 to notify, for example, that dangerous driving such as abrupt braking or abrupt steering has been detected. It should be noted that this notice is also given in consideration of a level (frequency) set by the user.

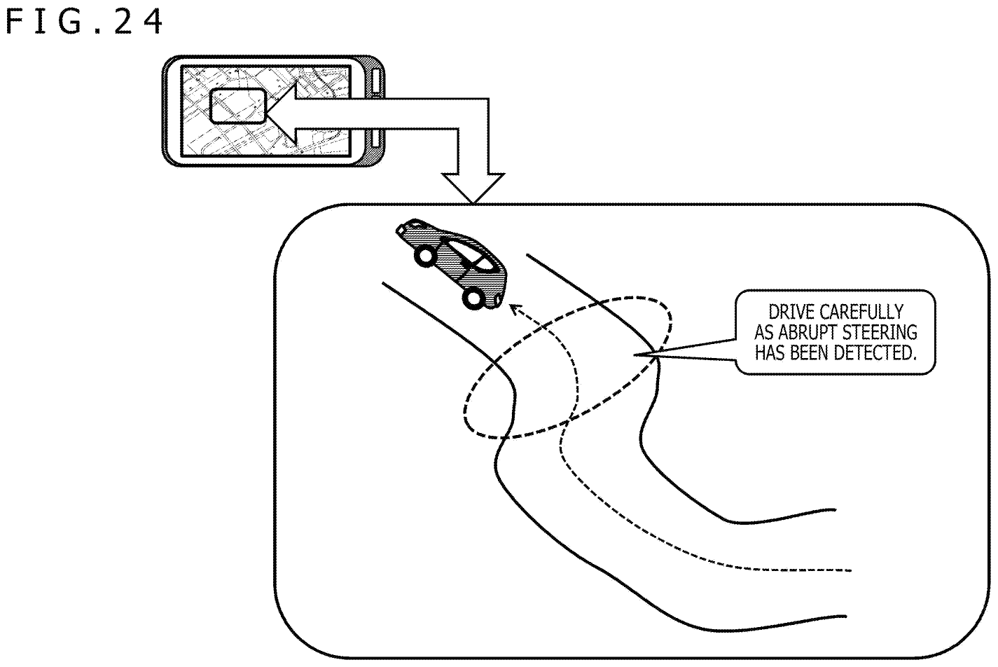

FIG. 24 illustrates an example of the notification process. As illustrated in FIG. 24, in the case where abrupt steering, for example, is detected, display data is output to notify the user that abrupt steering has been detected.

(Step S612)

In step S612, which is a final step, a decision is made as to whether or not the traveling has ended. In the case where the traveling has ended, the driving behavior estimation process based on the terminal-acquired information acquired by the mobile terminal is terminated.

In the case where the traveling has yet to end, the process returns to step S601, tasks such as updating the map are performed, and the processes of step S601 and subsequent steps are continuously performed.

As described above, during traveling, the driving behavior estimation process is continuously performed on the basis of the terminal-acquired information acquired by the mobile terminal, and the management server 30 continuously performs processes of calculating a driving behavior estimate, estimation reliability, and various scores and stores calculated data in the driving behavior analysis result DB 82.

[5-(3) Process after Traveling by Use of the Driving Behavior Estimation Application]

A description will next be given of a process performed after traveling by use of the driving behavior estimation application.

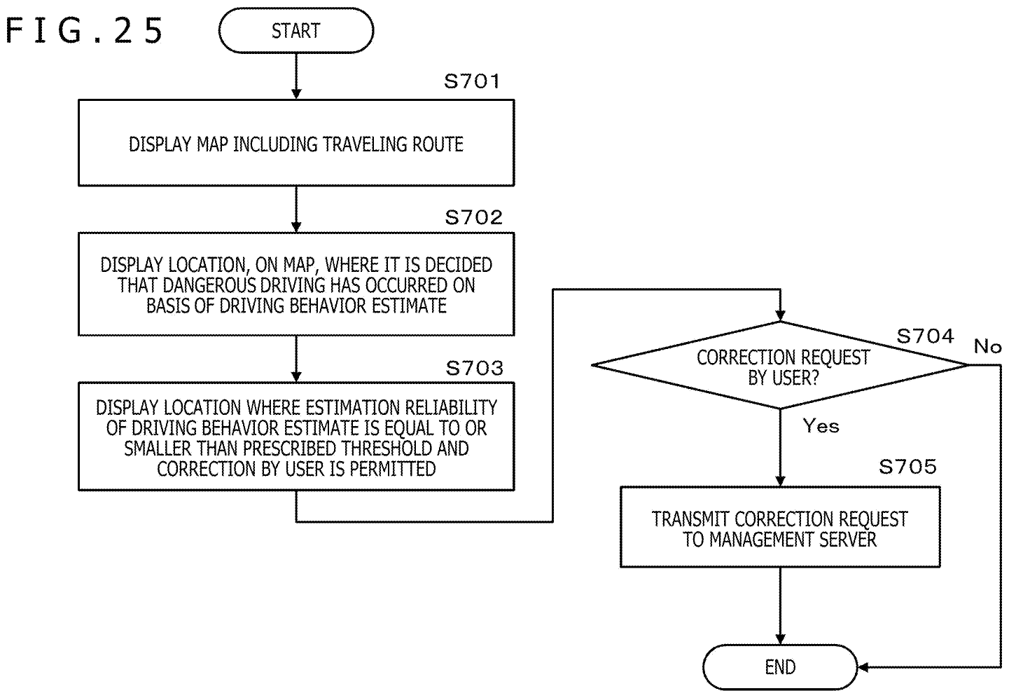

A description will be given of a processing sequence after traveling by use of the driving behavior estimation application 22 performed by the mobile terminal 20 with reference to a flowchart illustrated in FIG. 25.

Processes in the respective steps of the flow illustrated in FIG. 25 will be described in order.

(Step S701)

First, in step S701, map information including a traveled route is transmitted from the management server 30 to the mobile terminal 20 for display on the display section of the mobile terminal 20. As described earlier, the management server 30 has the map information DB 83 and further has, recorded therein, a route traveled by the vehicle on the basis of the current location information received from the mobile terminal 20.

(Step S702)

Further, in step S702, the management server 30 displays, on top of the map information displayed on the mobile terminal 20, locations where it is decided that dangerous driving has occurred on the basis of the driving behavior estimate and details of the dangerous driving.

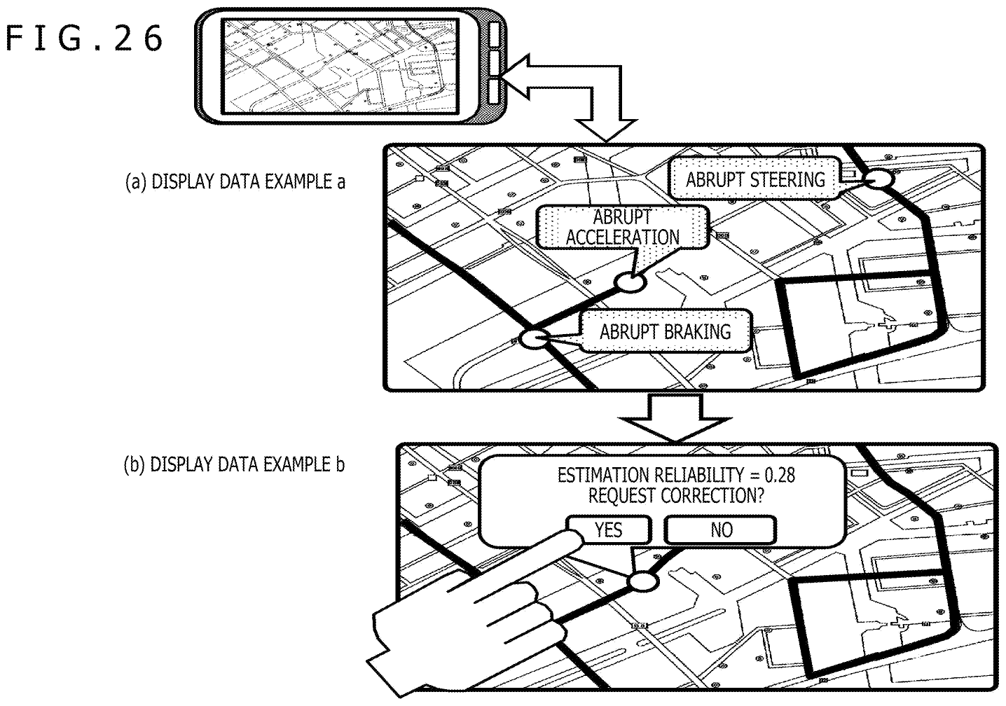

FIG. 26 illustrates specific examples.

For example, as illustrated in a display data example ‘a’ in FIG. 26(a), a location where it is decided that dangerous driving has occurred on the basis of the driving behavior estimate and details of the dangerous driving are displayed on top of the map information displayed on the mobile terminal 20.

(Step S703)

Further, in step S703, the management server 30 displays, on the mobile terminal 20, a location where the estimation reliability of the driving behavior estimate is equal to or smaller than a prescribed threshold and where correction by the user is permitted.

FIG. 26(b) illustrates a specific example.

For example, as illustrated in a display data example ‘b’ in FIG. 26(b), a location where the estimation reliability of the driving behavior estimate is equal to or smaller than the prescribed threshold and where correction by the user is permitted is displayed on top of the map information displayed on the mobile terminal 20.

For example, in the case where the prescribed threshold is 0.3, a location with estimation reliability of 0.3 or less is displayed. Further, a message is displayed to inquire whether or not the user is going to request correction.

(Steps S704 and S705)

The management server 30 decides in step S704 whether or not the user has made a request for correction.

In the case where the user touches a “Yes” region illustrated in the display data example ‘b’ in FIG. 26(b), a correction request is transmitted to the management server 30.

The management server 30 receives a number of correction requests from mobile terminals carried by many users of the vehicles that have completed their traveling.

It should be noted that although, in the example described with reference to step S703 in the flow of FIG. 25 and FIG. 26, information regarding only those locations with estimation reliability equal to or lower than a threshold is displayed, estimation reliabilities of all locations may be displayed in response to a user request regardless of the estimation reliability.

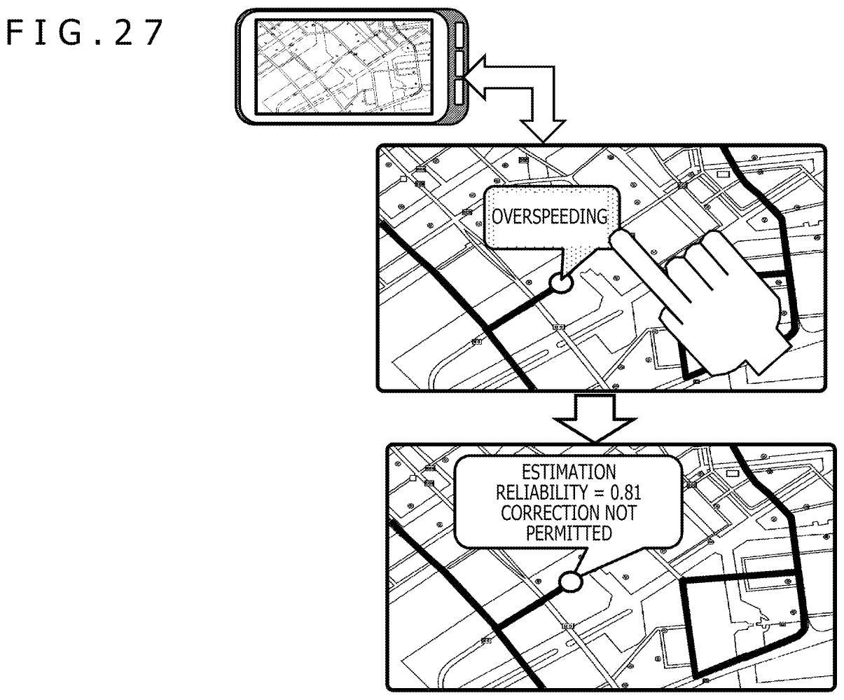

For example, as illustrated in a display data example ‘a’ in FIG. 27(a), a location where it is decided that dangerous driving has occurred on the basis of the driving behavior estimate and details of the dangerous driving are displayed on top of the map information displayed on the mobile terminal 20, and the user touches the region where such information is displayed.

This process causes an estimation reliability value corresponding to the driving behavior estimate to be displayed as illustrated in FIG. 27(b). This estimation reliability is 0.81 which is larger than the prescribed threshold of 0.3. As a result, the user cannot request correction. In this case, a message is displayed to indicate that correction request is not permitted.

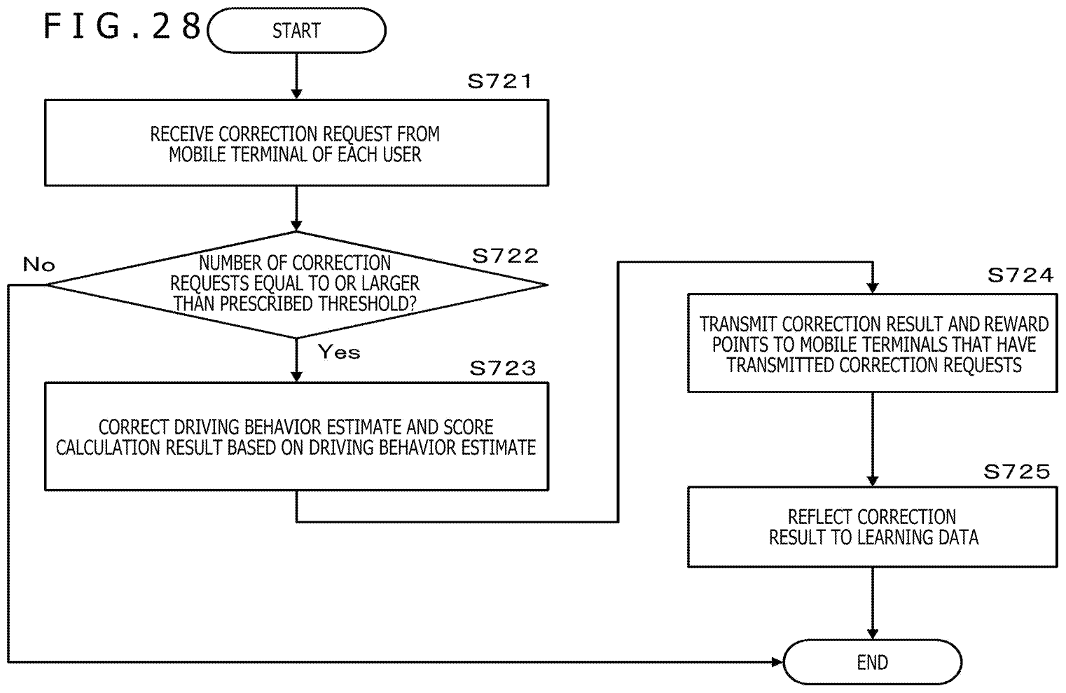

A description will next be given of a processing sequence of a process for the management server 30 to receive a correction request from the mobile terminal and make a correction with reference to a flowchart illustrated in FIG. 28.

Processes in the respective steps of the flow illustrated in FIG. 28 will be described in order.

(Step S721)

First, in step S721, the management server 30 receives a correction request from the mobile terminal 20 of each user.

(Step S722)

Next, in step S722, the management server 30 decides whether or not the number of correction requests received from the mobile terminals 20 has reached or exceeded a prescribed threshold.

In the case where the number of correction requests has yet to reach or exceed the prescribed threshold, the process is terminated.

Meanwhile, in the case where it is decided that the number of correction requests has reached or exceeded the prescribed threshold, the process proceeds to step S723.

(Step S723)

In the case where it is decided in step S722 that the number of correction requests has reached or exceeded the prescribed threshold, the process proceeds to step S723.

The management server 30 corrects, in step S723, the driving behavior estimate and the score calculation result based on the driving behavior estimate.

(Step S724)

Further, in step S724, the management server 30 transmits a correction result and reward points to the mobile terminals that have transmitted correction requests.

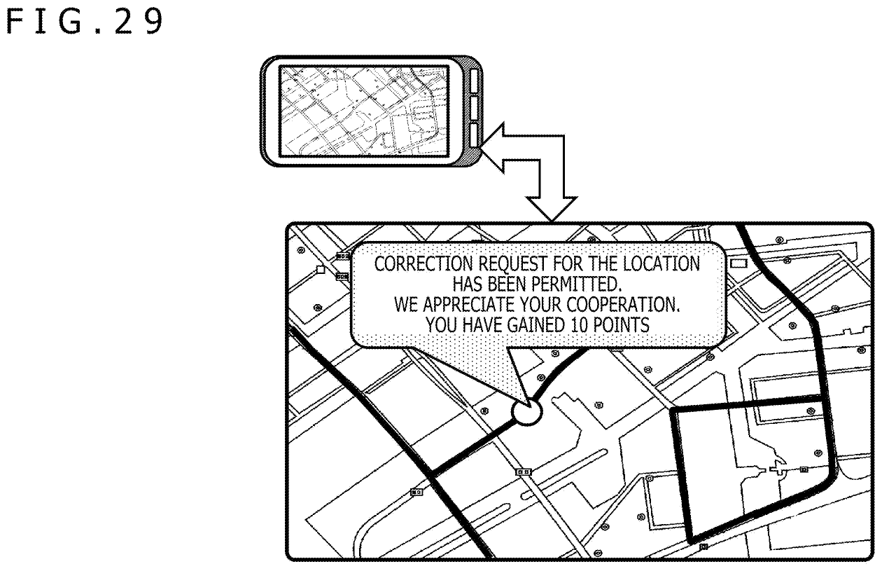

FIG. 29 illustrates a specific example.

As illustrated in FIG. 29, the location where the user's driving behavior has been decided dangerous and the user has made a correction request is displayed, and a message indicating that the driving behavior estimate at the location and the score have been corrected is displayed. Further, another message is also displayed to indicate that reward points have been granted to the user as a result of permission of the correction.

It should be noted that the reward points are specifically points for discount on merchandise, points applied to discount on insurance premiums, and the like.

The management server 30 manages granting and usage of these points as well through cooperation with other information provision servers and service provision servers.

(Step S725)

Further, in step S725, the management server 30 performs a process of reflecting the correction result into the learning data. For example, the management server 30 performs a process of correcting the driving behavior estimate and the score calculation results based on the driving behavior estimate stored in the driving behavior analysis result database 82 and reflecting the correction result into the learning data.

### [6. Configuration Example of the Information Processing Apparatus]

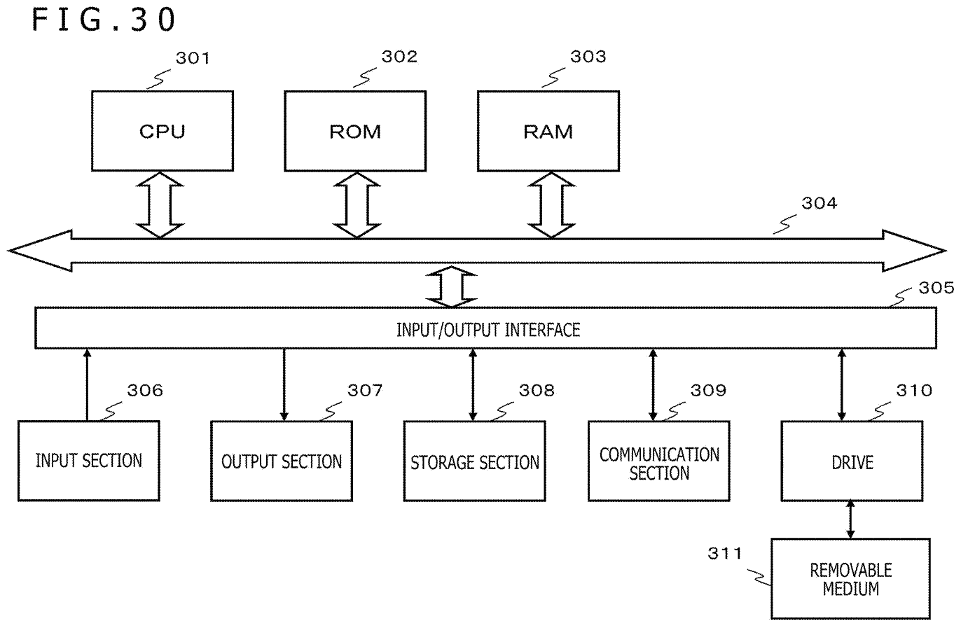

A description will next be given of a hardware configuration example of an information processing apparatus applicable as the mobile terminal 20 or the management server 30 with reference to FIG. 30.

The information processing apparatus applicable as the mobile terminal 20 or the management server 30 has, for example, a hardware configuration illustrated in FIG. 30.

A CPU (Central Processing Unit) 301 functions as a data processing section that carries out various processes in accordance with a program stored in a ROM (Read Only Memory) 302 or a storage section 308. For example, the CPU 301 carries out processes according to the sequences described in the above embodiment. A RAM (Random Access Memory) 303 stores the program to be executed by the CPU 301, data, and the like. The CPU 301, the ROM 302, and the RAM 303 are connected to one another by a bus 304.

The CPU 301 is connected to an input/output interface 305 via the bus 304, and an input section 306 including various switches, a keyboard, a touch panel, a mouse, a microphone, and the like, and an output section 307 including a display, a speaker, and the like, are connected to the input/output interface 305.

It should be noted that the input section of the mobile terminal 20 includes an information acquisition section such as an acceleration sensor, a speed sensor, a GPS sensor, and a rotation speed sensor for acquiring information used to estimate the driving behavior.

The CPU 301 of the management server 30 or the mobile terminal 20 estimates the driving behavior on the basis of the terminal-acquired information.

The storage section 308 connected to the input/output interface 305 includes, for example, a hard disk and stores the program to be executed by the CPU 301 and various kinds of data. A communication section 309 functions as a transmission/reception section for data communication via a network such as the Internet or a location area network and further as a broadcasting wave transmission/reception section and communicates with an external apparatus.

A drive 310 connected to the input/output interface 305 drives a removable medium 311 such as a magnetic disk, an optical disc, a magneto-optical disk, or a semiconductor memory such as a memory card and records data to and reads data from the removable medium 311.

### [7. Conclusion of the Configuration of the Present Disclosure]

An embodiment of the present disclosure has been described in detail above with reference to a specific embodiment. However, it is apparent that a person skilled in the art can modify or substitute the embodiment without departing from the gist of the present disclosure. That is, the present invention has been disclosed by way of illustration and should not be construed in a limited manner. In order to evaluate the gist of the present disclosure, the claims should be taken into consideration.

It should be noted that the technology disclosed in the present specification can also have the following configurations:

(1) An information processing apparatus including:

a data processing section configured to receive input of terminal-acquired information that is information acquired by a mobile terminal in a vehicle and perform a process of estimating a driving behavior of a driver of the vehicle, in which

the data processing section calculates a driving behavior estimate of the driver on the basis of the terminal-acquired information by applying a learning model generated in advance.

(2) The information processing apparatus of feature (1), in which

the learning model includes a learning model generated by receiving input of the terminal-acquired information and vehicle's observation information and configured to receive input of various kinds of terminal-acquired information to output the driving behavior estimate and estimation reliability that is reliability of the driving behavior estimate.

(3) The information processing apparatus of feature (1) or (2), in which

the terminal-acquired information includes at least any of acceleration information, rotation speed information, or position information.

(4) The information processing apparatus of any of features (1) to (3), in which

the data processing section performs a score calculation process to which the driving behavior estimate and estimation reliability that is reliability of the driving behavior estimate are applied.

(5) The information processing apparatus of feature (4), in which

the data processing section performs a process of calculating at least any of the following scores:

(1) a risk score as an index representing a degree of driving risk of the driver;

(2) a reliability score as an index value of overall estimation reliability of the driving behavior estimate; and

(3) an overall score representing a driving diagnosis result of the driver.

(6) The information processing apparatus of feature (5), in which

the data processing section calculates the overall score by a computation process by use of the risk score and the reliability score.

(7) The information processing apparatus of feature (5) or (6), in which

the data processing section calculates a score according to at least any of a vehicle type or a mobile terminal model.

(8) The information processing apparatus of any of features (5) to (7), in which

the data processing section generates information having road zone information determined on the basis of the score, the road zone information being superimposed on a map, and outputs the information to the mobile terminal.

(9) The information processing apparatus of feature (8), in which

the road zone information includes any of the following:

(1) information regarding road zones subject to driving score grading;

(2) information regarding road zones where dangerous driving has occurred; and

(3) information regarding road zones subject to reward point gaining.

(10) The information processing apparatus of feature (9), in which

the data processing section performs an advance notice process of notifying that a road zone where dangerous driving has occurred is approaching.

(11) The information processing apparatus of any of features (1) to (9), in which

the data processing section performs an after-the-fact notice process of notifying that a dangerous driving behavior has been performed.

(12) The information processing apparatus of any of features (1) to (10), in which

the data processing section receives a request to correct a driving behavior estimation result or a score calculation result based on the driving behavior estimation result from the mobile terminal and performs a correction process.

(13) The information processing apparatus of feature (12), in which

in a case where a correction process is performed on the basis of the correction request, the data processing section grants a reward point to a user whose mobile terminal has transmitted the correction request.

(14) An information processing system including:

a management server; and

a mobile terminal, in which

the mobile terminal includes a mobile terminal provided in a vehicle,

terminal-acquired information acquired by the mobile terminal is transmitted to the management server, and

the management server inputs the terminal-acquired information received from the mobile terminal to a learning model to output a driving behavior estimate of a driver of the vehicle.

(15) The information processing system of feature (14), in which

the management server inputs the terminal-acquired information received from the mobile terminal to a learning model to output the driving behavior estimate and estimation reliability that is reliability of the driving behavior estimate.

(16) The information processing system of feature (14) or (15), in which

the management server performs a process of calculating at least any of the following, by applying the driving behavior estimate and estimation reliability that is reliability of the driving behavior estimate:

(1) a risk score as an index representing a degree of driving risk of the driver;

(2) a reliability score as an index value of overall estimation reliability of the driving behavior estimate; and

(3) an overall score representing a driving diagnosis result of the driver.

(17) An information processing method performed in an information processing apparatus, the information processing apparatus including

a data processing section configured to receive input of terminal-acquired information that is information acquired by a mobile terminal in a vehicle, and perform a process of estimating a driving behavior of a driver of the vehicle, in which

the data processing section calculates a driving behavior estimate of the driver on the basis of the terminal-acquired information by applying a learning model generated in advance.

(18) An information processing method performed in an information processing system including a management server and a mobile terminal, in which

the mobile terminal includes a mobile terminal provided in a vehicle,

terminal-acquired information acquired by the mobile terminal is transmitted to the management server, and

the management server inputs the terminal-acquired information received from the mobile terminal to a learning model to output a driving behavior estimate of a driver of the vehicle.

(19) A program for causing information processing to be performed in an information processing apparatus, the information processing apparatus including

a data processing section configured to receive input of terminal-acquired information that is information acquired by a mobile terminal in a vehicle and perform a process of estimating a driving behavior of a driver of the vehicle,

the program causing the data processing section to calculate a driving behavior estimate of the driver on the basis of the terminal-acquired information by applying a learning model generated in advance.

Also, the series of processes described in the present specification can be performed by hardware, software, or a combination thereof. In the case where the series of processes are performed by software, a program storing the processing sequences can be installed to a memory of a computer incorporated in dedicated hardware or a general-purpose computer capable of performing a variety of processing tasks for execution. For example, the program can be recorded in a recording medium in advance. In addition to installation to a computer from a recording medium, the program can be received via a network such as LAN (Local Area Network) or the Internet and installed to a built-in recording medium such as a hard disk.

It should be noted that various processes described in the present specification may be performed not only chronologically according to the description but also in parallel or individually in a manner according to a processing capability of the apparatus handling the processes or as necessary. Also, the term “system” in the present specification refers to a configuration of a logical set of a plurality of apparatuses, and the apparatuses, each serving as a component, need not necessarily be accommodated in the same housing.

### INDUSTRIAL APPLICABILITY

As described above, according to the configuration of the embodiment of the present disclosure, a configuration is realized that inputs terminal-acquired information of a mobile terminal in a vehicle to a learning model, estimates a driver's driving behavior, and performs processes such as calculating a score on the basis of the estimation result and giving a notice.

Specifically, for example, terminal-acquired information acquired by a mobile terminal in a vehicle such as acceleration information is input, and a process of estimating a driving behavior of a driver of the vehicle is performed. A driving behavior estimate of the driver and estimation reliability of the driving behavior estimate are calculated on the basis of the terminal-acquired information by applying a learning model. Further, processes of calculating a risk score that is an index representing the degree of driving risk of the driver, a reliability score that is an index value of overall estimation reliability of the driving behavior estimate, an overall score representing a driving diagnosis result of the driver, and the like are performed, and a notification process of giving a notice to a mobile terminal user on the basis of the scores, and the like are performed.

The present configuration realizes a configuration that inputs terminal-acquired information of a mobile terminal in a vehicle to a learning model, estimates a driver's driving behavior, and performs processes such as calculating a score on the basis of the estimation result and giving a notice.

### REFERENCE SIGNS LIST

10: Vehicle
11: Driver
20: Mobile terminal
21: Information acquisition application
22: Driving behavior estimation application
30: Management server
41, 42: Information provision server
43, 44: Service provision server
50: Terminal-acquired information
60: Observation information
70: Learning data
80: Learning process section
81: Learning model
90: Driving behavior estimation section
301: CPU
302: ROM
303: RAM
304: Bus
305: Input/output interface
306: Input section
307: Output section
308: Storage section
309: Communication section
310: Drive
311: Removable medium

1. An information processing apparatus comprising:
a data processing section configured to receive input of terminal-acquired information that is information acquired by a mobile terminal in a vehicle and perform a process of estimating a driving behavior of a driver of the vehicle, wherein
the data processing section calculates a driving behavior estimate of the driver on a basis of the terminal-acquired information by applying a learning model generated in advance.

2. The information processing apparatus of claim 1, wherein
the learning model includes a learning model generated by receiving input of the terminal-acquired information and vehicle's observation information and configured to receive input of various kinds of terminal-acquired information to output the driving behavior estimate and estimation reliability that is reliability of the driving behavior estimate.

3. The information processing apparatus of claim 1, wherein
the terminal-acquired information includes at least any of acceleration information, rotation speed information, or position information.

4. The information processing apparatus of claim 1, wherein
the data processing section performs a score calculation process to which the driving behavior estimate and estimation reliability that is reliability of the driving behavior estimate are applied.

5. The information processing apparatus of claim 4, wherein
the data processing section performs a process of calculating at least any of the following scores:
(1) a risk score as an index representing a degree of driving risk of the driver;
(2) a reliability score as an index value of overall estimation reliability of the driving behavior estimate; and
(3) an overall score representing a driving diagnosis result of the driver.

6. The information processing apparatus of claim 5, wherein
the data processing section calculates the overall score by a computation process by use of the risk score and the reliability score.

7. The information processing apparatus of claim 5, wherein
the data processing section calculates a score according to at least any of a vehicle type or a mobile terminal model.

8. The information processing apparatus of claim 5, wherein
the data processing section generates information having road zone information determined on a basis of the score, the road zone information being superimposed on a map, and outputs the information to the mobile terminal.

9. The information processing apparatus of claim 8, wherein
the road zone information includes any of the following:
(1) information regarding road zones subject to driving score grading;
(2) information regarding road zones where dangerous driving has occurred; and
(3) information regarding road zones subject to reward point gaining.

10. The information processing apparatus of claim 9, wherein
the data processing section performs an advance notice process of notifying that a road zone where dangerous driving has occurred is approaching.

11. The information processing apparatus of claim 1, wherein
the data processing section performs an after-the-fact notice process of notifying that a dangerous driving behavior has been performed.

12. The information processing apparatus of claim 1, wherein
the data processing section receives a request to correct a driving behavior estimation result or a score calculation result based on the driving behavior estimation result from the mobile terminal and performs a correction process.

13. The information processing apparatus of claim 12, wherein
in a case where a correction process is performed on a basis of the correction request, the data processing section grants a reward point to a user whose mobile terminal has transmitted the correction request.

14. An information processing system comprising:
a management server; and
a mobile terminal, wherein
the mobile terminal includes a mobile terminal provided in a vehicle,
terminal-acquired information acquired by the mobile terminal is transmitted to the management server, and
the management server inputs the terminal-acquired information received from the mobile terminal to a learning model to output a driving behavior estimate of a driver of the vehicle.

15. The information processing system of claim 14, wherein
the management server inputs the terminal-acquired information received from the mobile terminal to a learning model to output the driving behavior estimate and estimation reliability that is reliability of the driving behavior estimate.

16. The information processing system of claim 14, wherein
the management server performs a process of calculating at least any of the following, by applying the driving behavior estimate and estimation reliability that is reliability of the driving behavior estimate:
(1) a risk score as an index representing a degree of driving risk of the driver;
(2) a reliability score as an index value of overall estimation reliability of the driving behavior estimate; and
(3) an overall score representing a driving diagnosis result of the driver.

17. An information processing method performed in an information processing apparatus, the information processing apparatus including
a data processing section configured to receive input of terminal-acquired information that is information acquired by a mobile terminal in a vehicle, and perform a process of estimating a driving behavior of a driver of the vehicle, wherein
the data processing section calculates a driving behavior estimate of the driver on a basis of the terminal-acquired information by applying a learning model generated in advance.

18. An information processing method performed in an information processing system including a management server and a mobile terminal, wherein
the mobile terminal includes a mobile terminal provided in a vehicle,
terminal-acquired information acquired by the mobile terminal is transmitted to the management server, and
the management server inputs the terminal-acquired information received from the mobile terminal to a learning model to output a driving behavior estimate of a driver of the vehicle.

19. A program for causing information processing to be performed in an information processing apparatus, the information processing apparatus including
a data processing section configured to receive input of terminal-acquired information that is information acquired by a mobile terminal in a vehicle and perform a process of estimating a driving behavior of a driver of the vehicle,
the program causing the data processing section to calculate a driving behavior estimate of the driver on a basis of the terminal-acquired information by applying a learning model generated in advance.
